(19) United States
(12) Patent Application Publication
(10) Pub. No.: US 2020/0264973 A1
(43) Pub. Date: Aug. 20, 2020

(54) METHOD AND APPARATUS FOR MANAGING MAP DATA IN MEMORY SYSTEM

(71) Applicant: SK hynix Inc., Gyeonggi-do (KR)

(72) Inventor: Jong-Hwan LEE, Gyeonggi-do (KR)

(21) Appl. No.: 16/726,733

(22) Filed: Dec. 24, 2019

(30) Foreign Application Priority Data
Feb. 19, 2019 (KR) 10-2019-0018972

(51) Int. Cl. G06F 12/02; G06F 12/0873; G06F 12/0882; G06F 12/1045; G06F 13/16

(52) U.S. Cl. CPC G06F 12/0246; G06F 12/0873; G06F 12/0882; G06F 2212/7209; G06F 13/1668; G06F 2212/7201; G06F 12/1054

(57) ABSTRACT

A memory system includes a memory device including a plurality of memory elements, and suitable for storing L2P map data, and a controller suitable for controlling the memory device by storing at least a portion of the L2P map data and state information of the L2P map data, wherein the controller determines validity of a first physical address received together with an unmap request from an external device, and performs an unmap operation on the valid first physical address.

### CROSS-REFERENCE TO RELATED APPLICATION

The present application claims priority under 35 U.S.C. § 119(a) to Korean Patent Application No. 10-2019-0018972, filed on Feb. 19, 2019, the disclosure of which is incorporated herein by reference in its entirety.

### BACKGROUND

### 1. Field

Various embodiments relate to a memory system and a data processing device including the same, and more particularly, to a method and an apparatus for managing map data in a memory system.

### 2. Description of the Related Art

Recently, the paradigm for a computing environment has shifted to ubiquitous computing, which enables computer systems to be accessed anytime and everywhere. As a result, the use of portable electronic devices, such as mobile phones, digital cameras, notebook computers and the like, are rapidly increasing. Such portable electronic devices typically use or include a memory system that uses or embeds at least one memory device, i.e., a data storage device. The data storage device can be used as a main storage device or an auxiliary storage device of a portable electronic device.

Unlike a hard disk, a data storage device using a nonvolatile semiconductor memory device is advantageous in that it has excellent stability and durability because it has no mechanical driving part (e.g., a mechanical arm), and has high data access speed and low power consumption. In the context of a memory system having such advantages, an exemplary data storage device includes a USB (Universal Serial Bus) memory device, a memory card having various interfaces, a solidstate drive (SSD) or the like.

### SUMMARY

Various embodiments of the present invention are directed to a memory system, a data processing system and a method for driving the memory system and the data processing system, which may invalidate a physical address received with a write request from a host, without a search for map data, and thus not only improve the speed of performing an internal operation of the memory system related to a write operation but also increase convenience of invalid data management.

Various embodiments of the present invention are directed to a memory system, a data processing system and a method for driving the memory system and the data processing system, in which the memory system may upload only map data for data, which a host requests to be read, to the host, and thus reduce the overhead of data communication between the memory system and the host caused by unnecessary map up/down loading.

Various embodiments of the present invention are directed to a memory system, a data processing system and a method for driving the memory system and the data processing system, which may invalidate a physical address received with a write request from a host by changing state information corresponding to the physical address in the memory system, and thus improve the speed of performing a write operation and increase convenience of invalid data management.

Various embodiments of the present invention are directed to a memory system, a data processing system and a method for driving the memory system and the data processing system, which may reduce the overhead of the memory system, improve the lifespan of the memory system, and improve the speed of performing an unmap operation.

Since a memory system, a data processing system and a method for operating the memory system and the data processing system according to various embodiments of the present invention does not download map data from a memory device when performing an unmap operation corresponding to an unmap request UNMAP REQ transmitted from a host, there are provided a memory system, a data processing system and a method for driving the memory system and the data processing system, which may reduce the overhead of the memory system, improve the lifespan of the memory system, and improve the speed of performing an unmap operation.

Various embodiments of the present invention are directed to a memory system, a data processing system and a method for driving the memory system and the data processing system, which may determine the validity of a physical address received from a host and invalidate the corresponding mapping data without separately searching for map data in the case where the physical address is a valid physical address, when performing an unmap operation, and thus improve the speed of performing the unmap operation and increase convenience of invalid data management.

Various embodiments of the present invention are directed to a memory system, a data processing system and a method for driving the memory system and the data processing system, which may decrease the number of valid pages of a memory block including a memory element corresponding to a valid physical address transmitted from a host or the number of valid storage elements of a memory group, perform a garbage collection operation on a memory block having the number of valid pages less than a predetermined value, and perform an erase operation on a memory block having no valid pages, during an unmap operation, thereby more efficiently performing a background operation.

Various embodiments of the present invention are directed to a memory system, a data processing system and a method for driving the memory system and the data processing system, which may be implemented by changing and utilizing an existing interface without adding a separate hardware configuration or resources without the need to change the interface between a host and the memory system since the memory system, not the host, has a management authority for a physical address received together with an unmap request.

Since a memory system, a data processing system and a method for operating the memory system and the data processing system according to various embodiments of the present invention perform an unmap operation on a valid physical address among physical addresses received together with an unmap request UNMAP REQ, reliability of the data processing system including a host desired to directly control the memory system may be ensured.

According to an embodiment of the present invention, a memory system comprising: a memory device comprising a plurality of memory elements, and suitable for storing L2P map data; and a controller suitable for: controlling the memory device by storing at least a portion of the L2P map data and state information of the L2P map data, determining validity of a first physical address received together with an unmap request from an external device, and performing an unmap operation on the first physical address, when it is determined to be valid.

The unmap operation may comprise changing a value of state information corresponding to the valid first physical address or a logical address mapped to the valid first physical address, in order to invalidate the valid first physical address. The state information may comprise invalid address information, dirty information and unmap information. The controller may decrease a count of a number of valid pages of a memory block corresponding to the first physical address after performing the unmap operation. The controller may perform a garbage collection operation on a memory block having a number of valid pages less than a set number. The controller may perform an erase operation on a memory block having no valid page. The unmap request may comprise a discard command and an erase command. The controller may determine the validity of the first physical address using the state information. When the first physical address is not valid, the controller may search the L2P map data for a valid second physical address corresponding to a logical address received from the external device, and may perform the unmap operation on the valid second physical address found in the search. The L2P map data stored in the controller may comprise first verification information generated based on an encryption of the L2P map data and second verification information generated based on an update version of the L2P map data. The controller may determine the validity of the first physical address using the first verification information or the second verification information.

According to an embodiment of the present invention, a data processing system comprising: a memory system suitable for storing L2P map data of a plurality of memory elements; and a host suitable for storing at least a portion of the L2P map data, and transmitting an unmap request and a target physical address of the unmap request to the memory system, wherein the memory system may determine validity of the target physical address, and may perform an unmap operation on the target physical address, when it is determined as valid.

The memory system may determine the validity of the physical address using state information of the L2P map data. The state information may comprise invalid address information, dirty information and unmap information. The memory system may perform the unmap operation by changing a value of state information corresponding to the first physical address or a logical address mapped to the first physical address to invalidate the valid first physical address. The L2P map data stored in the memory system may comprise first verification information generated based on an encryption of the L2P map data and second verification information generated based on an update version of the L2P map data. The memory system may determine the validity of the physical address using the first verification information or the second verification information.

According to an embodiment of the present invention, a controller comprising: a memory suitable for storing L2P map data and state information of the L2P map data; and an operation performance module suitable for performing an unmap operation to invalidate a physical address, which is received together with an unmap request from an external device, by changing a value of the state information corresponding to the physical address. The L2P map data represents relationships between logical addresses and physical addresses of a plurality of nonvolatile memory elements. The operation performance module transmits at least a portion of the L2P map data to the external device.

According to an embodiment of the present invention, an operating method of a data processing system, the operating method comprising: storing, by a memory system, at least L2P map data and validity information of a valid piece within the L2P map data; caching, by a host, at least a portion of the L2P map data; providing, by the host, the memory system with an unmap request along with a physical address, which is retrieved from the cached portion; and invalidating, by the memory system, the validity information corresponding to the physical address in response to the unmap request.

These and other features and advantages of the present invention are not limited to the embodiments described above, and will become apparent to those skilled in the art of the present invention from the following detailed description in conjunction with the accompanying drawings.

### BRIEF DESCRIPTION OF THE DRAWINGS

FIG. 1 is a schematic diagram illustrating a data processing system in accordance with an embodiment of the present invention.

FIG. 2 is a schematic diagram illustrating a data processing system in accordance with another embodiment of the present invention.

FIG. 3 is a schematic diagram illustrating a data processing operation in a memory system in accordance with an embodiment of the present invention.

FIG. 4 is a schematic diagram illustrating a memory device in accordance with an embodiment of the present invention.

FIG. 5 illustrates a read operation of a host and a memory system in a data processing system according to an embodiment of the present invention.

FIG. 6 is a flowchart illustrating a process of initially uploading map data.

FIG. 7 is a block diagram illustrating a process of updating map data.

FIGS. 8A and 8B illustrates a method for encrypting map data.

FIGS. 9A to 9D illustrates a method for generating version information of map data.

FIG. 10 is a flowchart illustrating a method for performing an unmap operation of a memory system in accordance with an embodiment of the present invention.

FIGS. 11, 12A and 12B are diagrams illustrating an example of a method for performing an unmap operation by a data processing system in accordance with an embodiment of the present invention.

FIGS. 13A and 13B are flowcharts illustrating an example of a method for determining, by a memory system, validity of a physical address received from a host in accordance with an embodiment of the present invention.

FIG. 14 is a flowchart illustrating an example of a method for performing an unmap operation by a memory system in accordance with an embodiment of the present invention.

FIGS. 15A to 15E are conceptual diagrams illustrating examples of state information in accordance with an embodiment.

FIG. 16 is a flowchart illustrating another example of a method for performing an unmap operation by a memory system in accordance with an embodiment.

FIG. 17 is a flowchart illustrating still another example of a method for performing an unmap operation by a memory system in accordance with an embodiment of the present invention.

FIGS. 18 to 20 illustrate an example of utilizing a partial area in a memory in a host as a device which is capable of temporarily storing user data as well as metadata.

### DETAILED DESCRIPTION

Various embodiments of the disclosure are described below in more detail with reference to the for drawings. Elements and features of the disclosure, however, may be configured or arranged differently to form other embodiments, which may be variations of any of the disclosed embodiments. Thus, the invention is not limited to the embodiments set forth herein. Rather, the described embodiments are provided so that this disclosure is thorough and complete and fully conveys the scope of the disclosure to those skilled in the art to which this invention pertains. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance could also be termed a second or third element in another instance without departing from the spirit and scope of the invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via one or more intervening elements therebetween. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the invention. As used herein, singular forms are intended to include the plural forms, unless the context clearly indicates otherwise. The articles ‘a’ and ‘an’ as used in this application and the appended claims should generally be construed to mean ‘one or more’ unless specified otherwise or it is clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the disclosure and the relevant art, and not be interpreted in an idealized or overly formal sense unless expressly so defined herein.

In the following description, numerous specific details are set forth in order to provide a thorough understanding of the invention. The invention may be practiced without some or all of these specific details. In other instances, well-known process structures and/or processes have not been described in detail in order not to unnecessarily obscure the invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, various embodiments of the present invention are described below in detail with reference to the accompanying drawings. The following description focuses on details to facilitate understand of embodiments of the invention; well-known technical details may be omitted so as not to obscure features and aspects of the present invention.

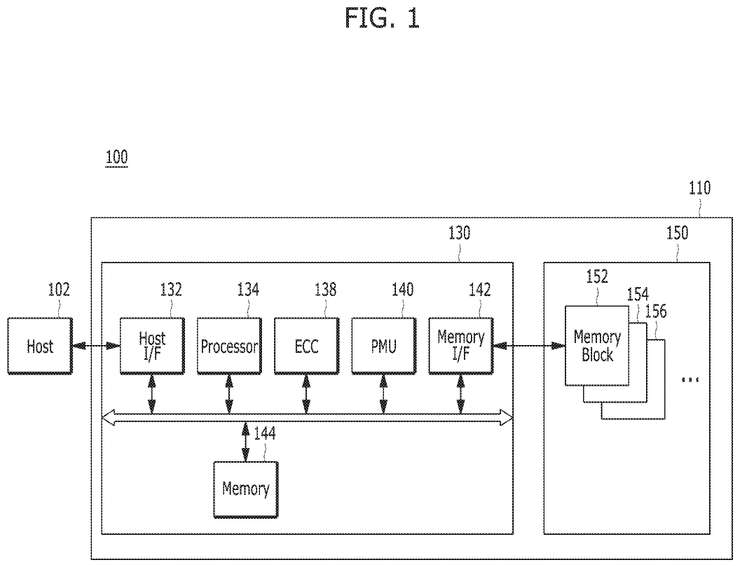

FIG. 1 is a block diagram illustrating a data processing system 100 in accordance with an embodiment of the present invention.

Referring to FIG. 1, a data processing system 100 data processing system 100 may include a host 102 operably engaged with a memory system 110.

The host 102 may include, for example, any of various portable electronic devices such as a mobile phone, an MP3 player and a laptop computer, or an electronic device such as a desktop computer, a game player, a television (TV), a projector, and/or the like.

The host 102 also includes at least one operating system (OS), which generally manages and controls functions and operations performed in the host 102. The OS can provide interoperability between the host 102 engaged with the memory system 110 and the user of the memory system 110. The OS may support functions and operations corresponding to a user's requests. By the way of example but not limitation, the OS can be a general operating system or a mobile operating system according to mobility of the host 102. The general operating system may be split into a personal operating system and an enterprise operating system according to system requirements or a user's environment. The personal operating system, including Windows and Chrome, may be subject to support services for general purposes. But the enterprise operating systems can be specialized for securing and supporting high performance, including Windows servers, Linux, Unix, and the like. Further, the mobile operating system may include Android, iOS, Windows mobile, and the like. The mobile operating system may be subject to support services or functions for mobility (e.g., a power saving function). The host 102 may include a plurality of operating systems. The host 102 may execute multiple operating systems with the memory system 110, corresponding to a user's request. The host 102 may transmit a plurality of commands corresponding to the user's requests into the memory system 110, thereby performing operations corresponding to commands within the memory system 110.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

The storage device(s) for the memory system 110 may be implemented with a volatile memory device, for example, a dynamic random access memory (DRAM) and a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM), and/or a flash memory.

The memory system 110 may include a controller 130 and a memory device 150. The memory device 150 may store data to be accessed by the host 102. The controller 130 may control storage of data in the memory device 150.

The controller 130 and the memory device 150 may be integrated into a single semiconductor device, which may be included in any of the various types of memory systems discussed above in the examples.

By way of example but not limitation, the controller 130 and the memory device 150 may be integrated into an SSD for improving an operation speed. When the memory system 110 is used as an SSD, the operating speed of the host 102 connected to the memory system 110 can be improved more than that of the host 102 implemented with a hard disk. In another embodiment, the controller 130 and the memory device 150 may be integrated into one semiconductor device to form a memory card, such as a PC card (PCMCIA), a compact flash card (CF), a memory card such as a smart media card (SM, SMC), a memory stick, a multimedia card (MMC, RS-MMC, MMC micro), a SD card (SD, mini SD, microSD, SDHC), a universal flash memory, or the like.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device and may retain data stored therein even without electrical power being supplied. The memory device 150 may store data provided from the host 102 through a write operation, while providing data stored therein to the host 102 through a read operation. The memory device 150 may include a plurality of memory blocks 152, 154, 156, each of which may include a plurality of pages. Each of the plurality of pages may include a plurality of memory cells to which a plurality of word lines (WL) are electrically coupled. The memory device 150 also includes a plurality of memory dies, each of which includes a plurality of planes, each of which includes a plurality of memory blocks 152, 154, 156. In addition, the memory device 150 may be a non-volatile memory device, for example a flash memory, wherein the flash memory may be embodied in a three-dimensional stack structure.

The controller 130 may control overall operations of the memory device 150, such as read, write, program, and erase operations. For example, the controller 130 may control the memory device 150 in response to a request from the host 102. The controller 130 may provide data, read from the memory device 150, to the host 102. The controller 130 may also store data, provided by the host 102, into the memory device 150.

The controller 130 may include a host interface (I/F) 132, a processor 134, an error correction code (ECC) component 138, a power management unit (PMU) 140, a memory interface (I/F) 142, and memory 144, all operatively coupled via an internal bus.

The host interface 132 may process commands and data provided by the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI), and/or integrated drive electronics (IDE). In accordance with an embodiment, the host interface 132 is a component for exchanging data with the host 102, which may be implemented through firmware called a host interface layer (HIL).

The ECC component 138 can correct error bits of the data to be processed in (e.g., outputted from) the memory device 150, which may include an ECC encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in a data read from the memory device 150 when the controller 130 reads the data stored in the memory device 150. In other words, after performing error correction decoding on the data read from the memory device 150, the ECC component 138 can determine whether the error correction decoding has succeeded and output an instruction signal (e.g., a correction success signal or a correction fail signal). The ECC component 138 can use the parity bit which is generated during the ECC encoding process, for correcting the error bit of the read data. When the number of the error bits is greater than or equal to a threshold number of correctable error bits, the ECC component 138 might not correct error bits but instead may output an error correction fail signal indicating failure in correcting the error bits.

The ECC component 138 may perform an error correction operation based on a coded modulation such as a low density parity check (LDDC) code, a Bose-Chaudhuri-Hocquenghem (BCH) code, a turbo code, a Reed-Solomon (RS) code, a convolution code, a recursive systematic code (RSC), a trellis-coded modulation (TCM), and/or a Block coded modulation (BCM). The ECC component 138 may include any and all circuits, modules, systems or devices for performing the error correction operation based on at least one of the above described codes.

The PMU 140 may manage electrical power provided in the controller 130.

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134 in a case when the memory device 150 is a flash memory and, in particular, when the memory device 150 is a NAND flash memory. The memory interface 142 can provide an interface for handling commands and data between the controller 130 and the memory device 150, for example, operations of NAND flash interface, in particular, operations between the controller 130 and the memory device 150. In accordance with an embodiment, the memory interface 142 can be implemented through firmware called a Flash Interface Layer (FIL) as a component for exchanging data with the memory device 150.

The memory 144 may support operations performed by the memory system 110 and the controller 130. The memory 144 may store temporary or transactional data generated or delivered for operations in the memory system 110 and the controller 130. The controller 130 may control the memory device 150 in response to a request from the host 102. The controller 130 may deliver data read from the memory device 150 into the host 102. The controller 130 may store data received from the host 102 in the memory device 150. The memory 144 may be used to store data for the controller 130 and the memory device 150 to perform operations such as read operations or program/write operations.

The memory 144 may be implemented as a volatile memory. The memory 144 may be implemented with a static random access memory (SRAM), a dynamic random access memory (DRAM), or both. Although FIG. 1 illustrates, for example, the second memory 144 disposed within the controller 130, embodiments are not limited thereto. That is, the memory 144 may be located within or external to the controller 130. For instance, the memory 144 may be embodied by an external volatile memory having a memory interface transferring data and/or signals between the memory 144 and the controller 130.

The memory 144 can store data necessary for performing operations such as data writing and data reading requested by the host 102 and/or data transfer between the memory device 150 and the controller 130 for background operations such as garbage collection and wear levelling as described above. In accordance with an embodiment, for supporting operations in the memory system 110, the memory 144 may include a program memory, a data memory, a write buffer/cache, a read buffer/cache, a data buffer/cache, a map buffer/cache, and the like.

The processor 134 may be implemented with a microprocessor or a central processing unit (CPU). The memory system 110 may include one or more processors 134. The processor 134 may control the overall operations of the memory system 110. By way of example but not limitation, the processor 134 controls a program operation or a read operation of the memory device 150, in response to a write request or a read request entered from the host 102. In accordance with an embodiment, the processor 134 may use or execute firmware to control the overall operations of the memory system 110. Herein, the firmware may be referred to as a flash translation layer (FTL). The FTL may perform an operation as an interface between the host 102 and the memory device 150. The host 102 may transmit requests for write and read operations to the memory device 150 through the FTL.

The FTL may manage operations of address mapping, garbage collection, wear-leveling, and the like. Particularly, the FTL may load, generate, update, or store map data. Therefore, the controller 130 may map a logical address, which is entered from the host 102, with a physical address of the memory device 150 through the map data. The memory device 150 may look like a general storage device to perform a read or write operation because of the address mapping operation. Also, through the address mapping operation based on the map data, when the controller 130 tries to update data stored in a particular page, the controller 130 may program the updated data on another empty page and may invalidate old data of the particular page (e.g., update a physical address, corresponding to a logical address of the updated data, from the previous particular page to the another newly programmed page) due to a characteristic of a flash memory device. Further, the controller 130 may store map data of the new data into the FTL.

For example, when performing an operation requested from the host 102 in the memory device 150, the controller 130 uses the processor 134. The processor 134 engaged with the memory device 150 can handle instructions or commands corresponding to an command received from the host 102. The controller 130 can perform a foreground operation as a command operation, corresponding to an command received from the host 102, such as a program operation corresponding to a write command, a read operation corresponding to a read command, an erase/discard operation corresponding to an erase/discard command and a parameter set operation corresponding to a set parameter command or a set feature command with a set command.

For another example, the controller 130 may perform a background operation on the memory device 150 through the processor 134. By way of example but not limitation, the background operation for the memory device 150 includes copying data stored in a memory block among the memory blocks 152, 154, 156 and storing such data in another memory block, e.g., a garbage collection (GC) operation. The background operation can include moving data stored in at least one of the memory blocks 152, 154, 156 into at least another of the memory blocks 152, 154, 156, e.g., a wear leveling (WL) operation. During a background operation, the controller 130 may use the processor 134 for storing the map data stored in the controller 130 to at least one of the memory blocks 152, 154, 156 in the memory device 150, e.g., a map flush operation. A bad block management operation of checking or searching for bad blocks among the memory blocks 152, 154, 156 is another example of a background operation performed by the processor 134.

In the memory system 110, the controller 130 performs a plurality of command operations corresponding to a plurality of commands entered from the host 102. For example, when performing a plurality of program operations corresponding to a plurality of program commands, a plurality of read operations corresponding to a plurality of read commands, and a plurality of erase operations corresponding to a plurality of erase commands sequentially, randomly, or alternatively, the controller 130 can determine which channel(s) or way(s) among a plurality of channels or ways for connecting the controller 130 to a plurality of memory dies included in the memory 150 is/are proper or appropriate for performing each operation. The controller 130 can transmit or transmit data or instructions via determined channels or ways for performing each operation. The plurality of memory dies in the memory 150 can transmit an operation result via the same channels or ways, respectively, after each operation is complete. Then, the controller 130 may transmit a response or an acknowledge signal to the host 102. In an embodiment, the controller 130 can check a status of each channel or each way. In response to a command entered from the host 102, the controller 130 may select at least one channel or way based on the status of each channel or each way so that instructions and/or operation results with data may be delivered via selected channel(s) or way(s).

By way of example but not limitation, the controller 130 can recognize statuses regarding a plurality of channels (or ways) associated with a plurality of memory dies included in the memory device 150. The controller 130 may determine the state of each channel or each way as a busy state, a ready state, an active state, an idle state, a normal state, and/or an abnormal state. The controller's determination of which channel or way an instruction (and/or a data) is delivered through can be associated with a physical block address, e.g., which die(s) the instruction (and/or the data) is delivered into. The controller 130 can refer to descriptors delivered from the memory device 150. The descriptors can include a block or page of parameters that describe relevant information about the memory device 150, which is data with a set format or structure. For instance, the descriptors may include device descriptors, configuration descriptors, unit descriptors, and the like. The controller 130 can refer to, or use, the descriptors to determine via which channel(s) or way(s) an instruction or a data is exchanged.

A management unit (not shown) may be included in the processor 134. The management unit may perform bad block management of the memory device 150. The management unit may find bad memory blocks in the memory device 150, which are in unsatisfactory condition for further use, as well as perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may seriously aggravate the utilization efficiency of the memory device 150 having a 3D stack structure and the reliability of the memory system 110. Thus, reliable bad block management may enhance or improve performance of the memory system 110.

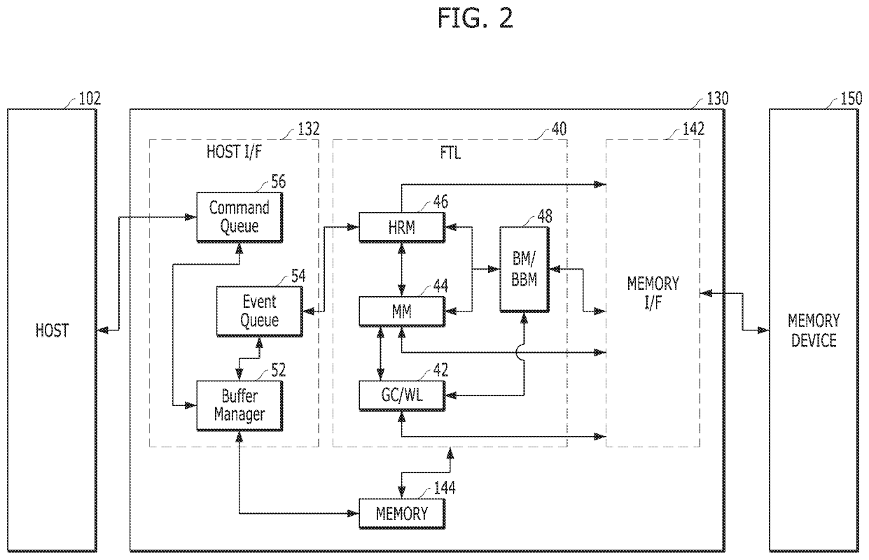

Referring to FIG. 2, a controller in a memory system in accordance with another embodiment of the present disclosure is described. The controller 130 cooperates with the host 102 and the memory device 150. As illustrated, the controller 130 includes a host interface 132, a flash translation layer (FTL) 40, as well as the host interface 132, the memory interface 142, and the memory 144 previously identified in connection with FIG. 1.

Although not shown in FIG. 2, in accordance with an embodiment, the ECC component 138 described with reference to FIG. 1 may be included in the flash translation layer (FTL) 40. In another embodiment, the ECC component 138 may be implemented as a separate module, a circuit, firmware, or the like, which is included in, or associated with, the controller 130.

The host interface 132 is for handling commands, data, and the like transmitted from the host 102. By way of example but not limitation, the host interface 132 may include a command queue 56, a buffer manager 52, and an event queue 54. The command queue 56 may sequentially store commands, data, and the like received from the host 102 and output them to the buffer manager 52 in an order in which they are stored. The buffer manager 52 may classify, manage, or adjust the commands, the data, and the like, which are received from the command queue 56. The event queue 54 may sequentially transmit events for processing the commands, the data, and the like received from the buffer manager 52.

A plurality of commands or data of the same characteristic, e.g., read or write commands, may be transmitted from the host 102, or commands and data of different characteristics may be transmitted to the memory system 110 after being mixed or jumbled by the host 102. For example, a plurality of commands for reading data (read commands) may be transmitted, or commands for reading data (read command) and programming/writing data (write command) may be alternately transmitted to the memory system 110. The host interface 132 may store commands, data, and the like, which are transmitted from the host 102, to the command queue 56 sequentially. Thereafter, the host interface 132 may estimate or predict what kind of internal operation the controller 130 will perform according to the characteristics of commands, data, and the like, which have been entered from the host 102. The host interface 132 can determine a processing order and a priority of commands, data and the like, based at least on their characteristics. According to characteristics of commands, data, and the like transmitted from the host 102, the buffer manager 52 in the host interface 132 is configured to determine whether the buffer manager should store commands, data, and the like in the memory 144, or whether the buffer manager should deliver the commands, the data, and the like to the flash translation layer (FTL) 40. The event queue 54 receives events, entered from the buffer manager 52, which are to be internally executed and processed by the memory system 110 or the controller 130 in response to the commands, the data, and the like transmitted from the host 102, so as to deliver the events into the flash translation layer (FTL) 40 in the order received.

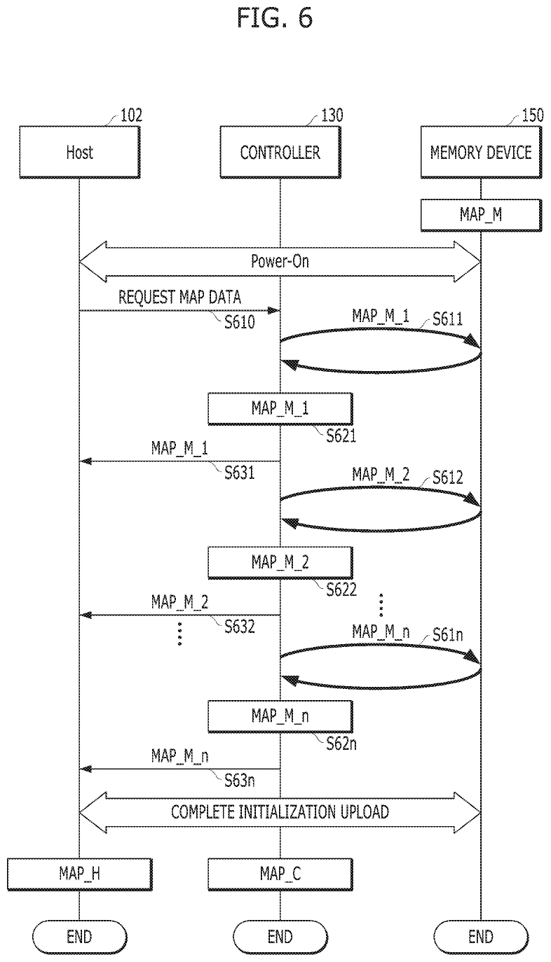

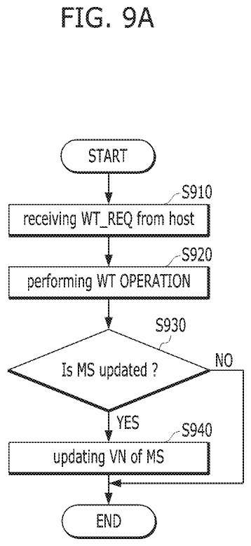

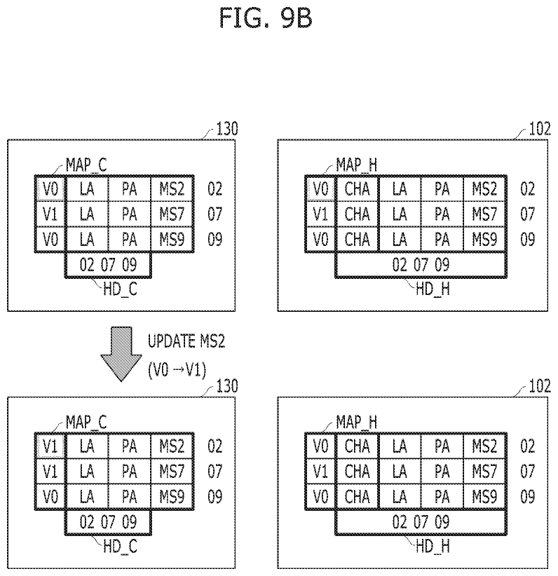

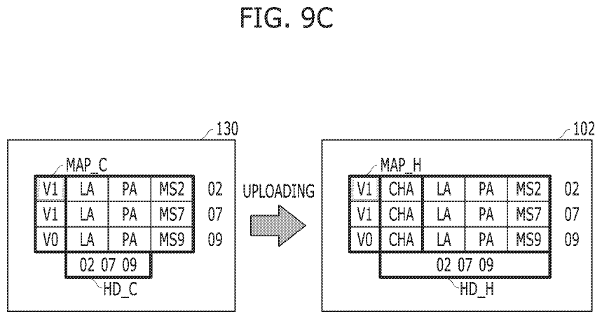

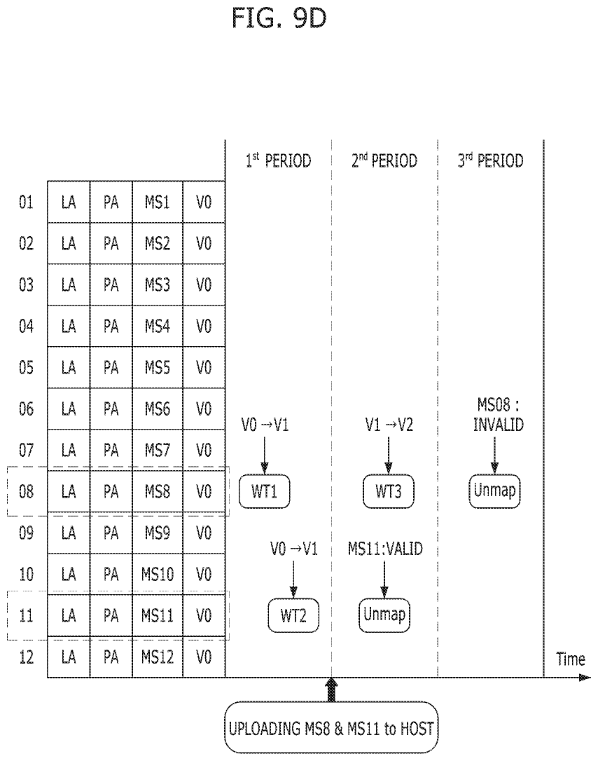

In accordance with an embodiment, the host interface 132 described with reference to FIG. 2 may perform some functions of the controller 130 described with reference to FIGS. 1 and 2. The host interface 132 may set the host memory 106, which is shown in FIG. 6 or 9, as a slave and add the host memory 106 as an additional storage space which is controllable or usable by the controller 130.

In accordance with an embodiment, the flash translation layer (FTL) 40 can include a host request manager (HRM) 46, a map manager (MM) 44, a state manager (GC/WL) 42, and a block manager (BM/BBM) 48. The host request manager 46 can manage the events entered from the event queue 54. The map manager 44 can handle or control a map data. The state manager 42 can perform garbage collection (GC) or wear leveling (WL). The block manager 48 can execute commands or instructions onto a block in the memory device 150.

By way of example but not limitation, the host request manager) 46 can use the map manager 44 and the block manager 48 to handle or process requests according to the read and program commands, and events which are delivered from the host interface 132. The host request manager 46 can transmit an inquiry request to the map data manager 44, to determine a physical address corresponding to the logical address which is entered with the events. The host request manager 46 can transmit a read request with the physical address to the memory interface 142, to process the read request (handle the events). On the other hand, the host request manager 46 can transmit a program request (write request) to the block manager 48, to program data to a specific empty page (a page with no data) in the memory device 150, and then, can transmit a map update request corresponding to the program request to the map manager 44, to update an item relevant to the programmed data in information of mapping the logical-physical addresses to each other.

Here, the block manager 48 can convert a program request delivered from the host request manager 46, the map data manager 44, and/or the state manager 42 into a flash program request used for the memory device 150, to manage flash blocks in the memory device 150. In order to maximize or enhance program or write performance of the memory system 110 (see FIG. 1), the block manager 48 may collect program requests and transmit flash program requests for multiple-plane and one-shot program operations to the memory interface 142. In an embodiment, the block manager 48 transmits several flash program requests to the memory interface 142 to enhance or maximize parallel processing of the multi-channel and multi-directional flash controller.

On the other hand, the block manager 48 can be configured to manage blocks in the memory device 150 according to the number of valid pages, select and erase blocks having no valid pages when a free block is needed, and select a block including the least number of valid pages when it is determined that garbage collection is necessary. The state manager 42 can perform garbage collection to move the valid data to an empty block and erase the blocks containing the moved valid data so that the block manager 48 may have enough free blocks (empty blocks with no data). If the block manager 48 provides information regarding a block to be erased to the state manager 42, the state manager 42 may check all flash pages of the block to be erased to determine whether each page is valid. For example, to determine validity of each page, the state manager 42 can identify a logical address recorded in an out-of-band (00B) area of each page. To determine whether each page is valid, the state manager 42 can compare the physical address of the page with the physical address mapped to the logical address obtained from the inquiry request. The state manager 42 transmits a program request to the block manager 48 for each valid page. A mapping table can be updated through the update of the map manager 44 when the program operation is complete.

The map manager 44 can manage a logical-physical mapping table. The map manager 44 can process requests such as queries, updates, and the like, which are generated by the host request manager 46 or the state manager 42. The map manager 44 may store the entire mapping table in the memory device 150 (e.g., a flash/non-volatile memory) and cache mapping entries according to the storage capacity of the memory 144. When a map cache miss occurs while processing inquiry or update requests, the map manager 44 may transmit a read request to the memory interface 142 to load a relevant mapping table stored in the memory device 150. When the number of dirty cache blocks in the map manager 44 exceeds a certain threshold, a program request can be sent to the block manager 48 so that a clean cache block is made and the dirty map table may be stored in the memory device 150.

On the other hand, when garbage collection is performed, the state manager 42 copies valid page(s) into a free block, and the host request manager 46 can program the latest version of the data for the same logical address of the page and currently issue an update request. When the status manager 42 requests the map update in a state in which copying of valid page(s) is not properly completed, the map manager 44 might not perform the mapping table update. It is because the map request is issued with old physical information if the status manger 42 requests a map update and a valid page copy is completed later. The map manager 44 may perform a map update operation to ensure accuracy only if the latest map table still points to the old physical address.

In accordance with an embodiment, at least one of the state manager 42, the map manager 44, or the block manager 48 can include circuitry for performing its own operation. As used in the present disclosure, the term ‘circuitry’ refers to any and all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” also covers an implementation of merely a processor (or multiple processors) or portion of a processor and its (or their) accompanying software and/or firmware. The term “circuitry” also covers, for example, and if applicable to a particular claim element, an integrated circuit for a storage device.

The memory device 150 can include a plurality of memory blocks. The plurality of memory blocks can be any of different types of memory blocks such as single-level cell (SLC) memory blocks, multi-level cell (MLC) memory blocks, or the like, according to the number of bits that can be stored or represented in one memory cell. Here, the SLC memory block includes a plurality of pages implemented by memory cells each storing one bit of data. The SLC memory block can have high data I/O operation performance and high durability. The MLC memory block includes a plurality of pages implemented by memory cells each storing multi-bit data (e.g., two bits or more). The MLC memory block can have larger storage capacity for the same space compared to the SLC memory block. The MLC memory block can be highly integrated in terms of storage capacity. In an embodiment, the memory device 150 may be implemented with different levels of MLC memory blocks, such as a double-level memory block, a triple-level cell (TLC) memory block, a quadruple-level cell (QLC) memory block, or a combination thereof. The double-level memory block may include a plurality of pages implemented by memory cells, each capable of storing 2-bit data. The triple-level cell (TLC) memory block can include a plurality of pages implemented by memory cells, each capable of storing 3-bit data. The quadruple-level cell (QLC) memory block can include a plurality of pages implemented by memory cells, each capable of storing 4-bit data. In another embodiment, the memory device 150 can be implemented with a block including a plurality of pages implemented by memory cells, each capable of storing five or more bits of data.

In an embodiment of the present disclosure, the memory device 150 is embodied as nonvolatile memory such as a flash memory such as a NAND flash memory, a NOR flash memory, and the like. Alternatively, the memory device 150 may be implemented by at least one of a phase change random access memory (PCRAM), a ferroelectrics random access memory (FRAM), a spin injection magnetic memory (STT-RAM), and a spin transfer torque magnetic random access memory (STT-MRAM), or the like.

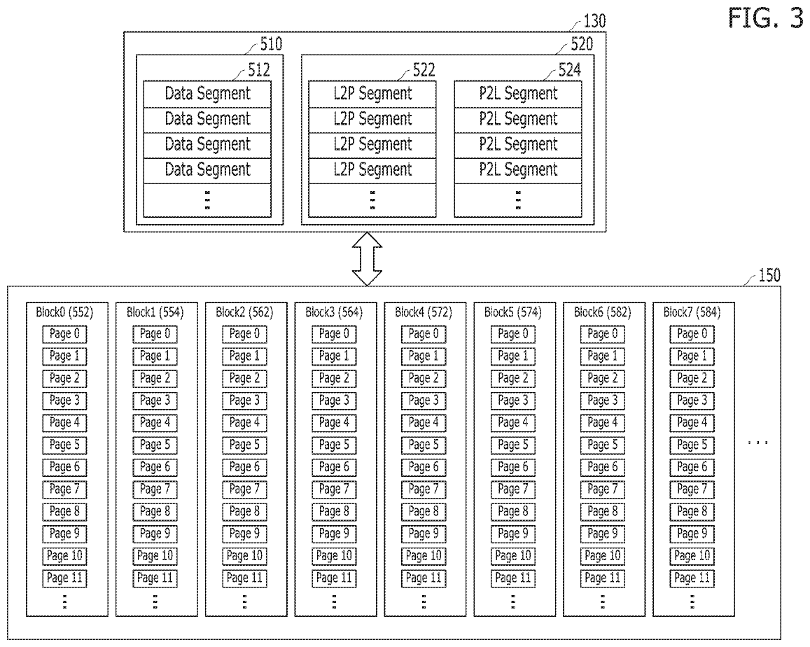

FIG. 3 is a schematic diagram illustrating a data processing operation with respect to a memory device in a memory system in accordance with an embodiment.

Referring to FIG. 3, the controller 130 may perform a command operation corresponding to a command received from the host 102, for example, a program operation corresponding to a write request. The controller 130 may write and store user data corresponding to the write request, in memory blocks 552, 554, 562, 564, 572, 574, 582 and 584 of the memory device 150. Also, in correspondence to the write operation to the memory blocks 552, 554, 562, 564, 572, 574, 582 and 584, the controller 130 may generate and update metadata for the user data and write and store the metadata in these memory blocks.

The controller 130 may generate and update information indicating that the user data are stored in the pages in the memory blocks 552, 554, 562, 564, 572, 574, 582 and 584 of the memory device 150, that is, generate and update the logical segments, that is, L2P segments, of first map data and the physical segments, that is, P2L segments, of second map data, and then, store the L2P segments and the P2L segments in the pages the memory blocks 552, 554, 562, 564, 572, 574, 582 and 584, by performing a map flush operation.

For example, the controller 130 may cache and buffer the user data corresponding to the write request received from the host 102, in a first buffer 510 in the memory 144 of the controller 130, that is, store data segments 512 of the user data in the first buffer 510 as a data buffer/cache. Then, the controller 130 may write and store the data segments 512 stored in the first buffer 510, in the pages in the memory blocks 552, 554, 562, 564, 572, 574, 582 and 584 of the memory device 150.

As the data segments 512 of the user data corresponding to the write request received from the host 102 are written and stored in the pages in the above-identified memory blocks, the controller 130 may generate the first map data and the second map data, and store the first map data and the second map data in a second buffer 520 in the memory 144. More specifically, the controller 130 may store L2P segments 522 of the first map data for the user data and P2L segments 524 of the second map data for the user data, in the second buffer 520 as a map buffer/cache. In the second buffer 520 in the memory 144 of the controller 130, there may be stored, as described above, the L2P segments 522 of the first map data and the P2L segments 524 of the second map data, or there may be stored a map list for the L2P segments 522 of the first map data and a map list for the P2L segments 524 of the second map data. The controller 130 may write and store the L2P segments 522 of the first map data and the P2L segments 524 of the second map data, which are stored in the second buffer 520, in the pages in the memory blocks 552, 554, 562, 564, 572, 574, 582 and 584 of the memory device 150.

Also, the controller 130 may perform a command operation corresponding to a command received from the host 102, for example, a read operation corresponding to a read request. The controller 130 may load user data corresponding to the read request, for example, L2P segments 522 of first map data and P2L segments 524 of second map data, in the second buffer 520, and check the L2P segments 522 and the P2L segments 524. After that, the controller 130 may read the user data stored in the pages included in corresponding memory blocks among the memory blocks 552, 554, 562, 564, 572, 574, 582 and 584 of the memory device 150, store data segments 512 of the read user data in the first buffer 510, and provide the data segments 512 to the host 102.

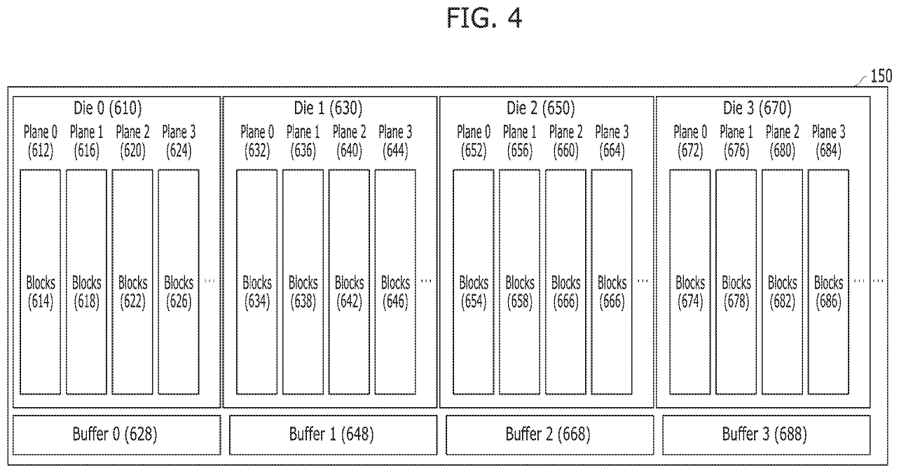

Referring to FIG. 4, the memory device 150 may include a plurality of memory dies, for example, memory dies 610, 630, 650 and 670. Each of the memory dies 610, 630, 650 and 670 may include a plurality of planes. For example, the memory die 610 may include planes 612, 616, 620 and 624. The memory die 630 may include planes 632, 636, 640 and 644. The memory die 650 may include planes 652, 656, 660 and 664, and the memory die 670 may include planes 672, 676, 680 and 684. The respective planes 612, 616, 620, 624, 632, 636, 640, 644, 652, 656, 660, 664, 672, 676, 680 and 684 in the memory dies 610, 630, 650 and 670 in the memory device 150 may include a plurality of memory blocks 614, 618, 622, 626, 634, 638, 642, 646, 654, 658, 662, 666, 674, 678, 682 and 686. Each block may include a plurality of pages, for example, 2^{M} pages, as described above with reference to FIG. 2. The plurality of memory dies of the memory device 150 may be grouped and memory dies in the same group coupled to the same channel. For example, the memory dies 610 and 650 may be coupled to one channel, and the memory dies 630 and 670 may be coupled to a different channel.

In an embodiment of the present disclosure, in consideration of program sizes in the memory blocks 614, 618, 622, 626, 634, 638, 642, 646, 654, 658, 662, 666, 674, 678, 682 and 686 of the respective planes 612, 616, 620, 624, 632, 636, 640, 644, 652, 656, 660, 664, 672, 676, 680 and 684 in the respective memory dies 610, 630, 650 and 670 of the memory device 150 as described above with reference to FIG. 4, user data and metadata of a command operation corresponding to a command received from the host 102 may be written and stored in the pages in the respective above-identified memory blocks. In particular, after grouping these memory blocks into a plurality of super memory blocks, user data and metadata of a command operation corresponding to a command received from the host 102 may be written and stored in the super memory blocks, for example, through a one shot program.

Each of the super memory blocks may include a plurality of memory blocks, for example, at least one memory block of a first memory block group and at least one memory block of a second memory block group. The first memory block group may contain memory blocks of a first die, and the second memory block group may contain memory blocks of a second die, where the first and second dies are coupled to different channels. Further, a plurality of memory blocks, for example, a first memory block and a second memory block, in a first memory block group coupled to a first channel may be of memory dies coupled to different ways of a channel, and a plurality of memory blocks, for example, a third memory block and a fourth memory block, in a second memory block group coupled to a second channel may be of memory dies coupled to different ways of a channel.

For example, a first super memory block may include four memory blocks, each of a different die, where two of the dies are coupled to one channel and the other two dies are coupled to a different channel. While it is described above that one super memory block includes 4 memory blocks, a super memory block may include any suitable number of memory blocks. For example, a super block may include only 2 memory blocks, each of dies coupled to separate channels.

In an embodiment of the present disclosure, in performing a program operation in the super memory blocks in the memory device 150, data segments of user data and meta segments of metadata for the user data may be stored in the plurality of memory blocks in the respective super memory blocks, through an interleaving scheme, in particular, a channel interleaving scheme, a memory die interleaving scheme or a memory chip interleaving scheme. To this end, the memory blocks in the respective super memory blocks may be of different memory dies, in particular, memory blocks of different memory dies coupled to different channels.

Moreover, in an embodiment of the present disclosure, in the case where, as described above, a first super memory block may include 4 memory blocks of 4 memory dies coupled to 2 channels, in order to ensure that a program operation is performed through a channel interleaving scheme and a memory die interleaving scheme, the first page of the first super memory block corresponds to the first page of a first memory block, the second page next to the first page of the first super memory block corresponds to the first page of a second memory block, the third page next to the second page of the first super memory block corresponds to the first page of a third memory block, and the fourth page next to the third page of the first super memory block corresponds to the first page of a fourth memory block. In an embodiment of the present disclosure, the program operation may be performed sequentially from the first page of the first super memory block.

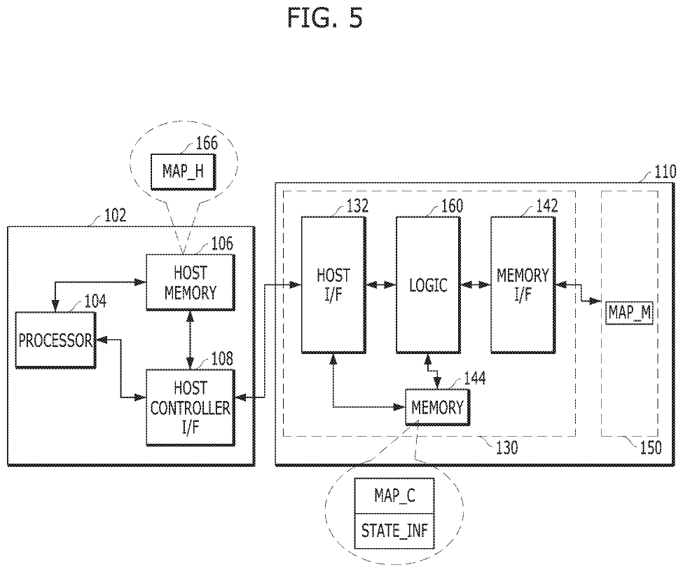

FIGS. 5 to 7 illustrate a case in which a part or portion of memory in a host can be used as a cache device for storing metadata used in the memory system.

Referring to FIG. 5, the host 102 may include a processor 104, host memory 106, and a host controller interface 108. The memory system 110 may include a controller 130 and a memory device 150. Herein, the controller 130 and the memory device 150 described with reference to FIG. 5 may correspond to the controller 130 and the memory device 150 described with reference to FIGS. 1 to 2.

FIG. 5 illustrates certain differences with respect to the data processing system shown in FIGS. 1 and 2. Particularly, a logic block 160 in the controller 130 may correspond to the flash translation layer (FTL) 40 described with reference to FIG. 2. However, according to an embodiment, the logic block 160 in the controller 130 may perform an additional function that the flash translation layer (FTL) 40 of FIG. 2 may not perform.

The host 102 may include the processor 104, which has a higher performance than that of the memory system 110. the host 102 also includes the host memory 106 which is capable of storing a larger amount of data than that of the memory system 110 that cooperates with the host 102. The processor 104 and the host memory 106 in the host 102 have an advantage in terms of space and upgradability. For example, the processor 104 and the host memory 106 have less of a space limitation than the processor 134 and the memory 144 in the memory system 110. The processor 104 and the host memory 106 may be replaceable with upgraded versions, which is different than the processor 134 and the memory 144 in the memory system 110. In the embodiment of FIG. 5, the memory system 110 can utilize the resources of the host 102 in order to increase the operation efficiency of the memory system 110.

As an amount of data which can be stored in the memory system 110 increases, an amount of metadata corresponding to the data stored in the memory system 110 also increases. When storage capability used to load the metadata in the memory 144 of the controller 130 is limited or restricted, the increase in an amount of loaded metadata may cause an operational burden on the controller 130. For example, because of the limitation of space or region allocated for metadata in the memory 144 of the controller 130, only some, but not all, of the metadata may be loaded. If the loaded metadata does not include specific metadata for a physical location to which the host 102 intends to access, the controller 130 must store the loaded metadata back into the memory device 150 if some of the loaded metadata has been updated, as well as load the specific metadata for the physical location the host 102 intends to access. These operations should be performed for the controller 130 to perform a read operation or a write operation directed by the host 102, and may degrade performance of the memory system 110.

Storage capability of the host memory 106 in the host 102 may be tens or hundreds of times larger than that of the memory 144 in the controller 130. The memory system 110 may transfer metadata 166 used by the controller 130 to the host memory 106 so that at least some part or portion of the host memory 106 may be accessed by the memory system 110. The part of the host memory 106 accessible by the memory system 110 can be used as a cache memory for address translation required for reading or writing data in the memory system 110. In this case, the host 102 translates a logical address into a physical address based on the metadata 166 stored in the host memory 106 before transmitting the logical address along with a request, a command, or an instruction to the memory system 110. Then, the host 102 can transmit the translated physical address with the request, the command, or the instruction to the memory system 110. The memory system 110, which receives the translated physical address with the request, the command, or the instruction, may skip an internal process of translating the logical address into the physical address and access the memory device 150 based on the physical address transferred. In this case, overhead (e.g., operational burden) of the controller 130 loading metadata from the memory device 150 for the address translation may be reduced or eliminated, and operational efficiency of the memory system 110 can be enhanced.

On the other hand, even if the memory system 110 transmits the metadata 166 to the host 102, the memory system 110 can control mapping information based on the metadata 166 such as metadata generation, erase, update, and the like. The controller 130 in the memory system 110 may perform a background operation such as garbage collection or wear leveling according to an operation state of the memory device 150 and may determine a physical address, i.e., which physical location in the memory device 150 data transferred from the host 102 is to be stored. Because a physical address of data stored in the memory device 150 may be changed and the host 102 has not recognized the changed physical address, the memory system 110 may control the metadata 166 on its own initiative.

While the memory system 110 controls metadata used for the address translation, it can be determined that the memory system 110 needs to modify or update the metadata 166 previously transmitted to the host 102. The memory system 110 can send a signal or metadata to the host 102 so as to request the update of the metadata 166 stored in the host 102. The host 102 may update the stored metadata 166 in the host memory 106 in response to a request delivered from the memory system 110. This allows the metadata 166 stored in the host memory 106 in the host 102 to be kept as the latest version such that, even though the host controller interface 108 uses the metadata 166 stored in the host memory 106, there is no problem in an operation that a logical address is translated into a physical address and the translated physical address is transmitted along with the logical address to the memory system 110.

The metadata 166 stored in the host memory 106 may include mapping information used for translating a logical address into a physical address.

Referring to FIG. 5, metadata associating a logical address with a physical address may include two distinguishable items: a first mapping information item used for translating a logical address into a physical address; and a second mapping information item used for translating a physical address into a logical address. Among them, the metadata 166 stored in the host memory 106 may include the first mapping information. The second mapping information can be primarily used for internal operations of the memory system 110, but might not be used for operations requested by the host 102 to store data in the memory system 110 or read data corresponding to a particular logical address from the memory system 110. In an embodiment, the second mapping information item might not be transmitted by the memory system 110 to the host 102.

The controller 130 in the memory system 110 can control (e.g., create, delete, update, etc.) the first mapping information item or the second mapping information item, and store either the first mapping information item or the second mapping information item to the memory device 150. Because the host memory 106 is a type of volatile memory, the metadata 166 stored in the host memory 106 may disappear when an event such as interruption of power supply to the host 102 and the memory system 110 occurs. Accordingly, the controller 130 in the memory system 110 might not only keep the latest state of the metadata 166 stored in the host memory 106, but also store the latest state of the first mapping information item or the second mapping information item in the memory device 150.

FIG. 6 is a flowchart illustrating a method in which the memory system 110 transmits all or a portion of the memory map data MAP_M to the host 102 at power-on. Referring to 6, the controller 130 loads some or all of a memory map data MAP_M stored in the memory device 150 and transmits memory map data MAP_M to the host 102 at power-on. Upon power-on, the host 102, the controller 130, and the memory device 150 may start an initialization uploading operation of a map data.

In S610, the host 102 may request map data from the controller 130. For example, the host 102 may designate and request a specific portion of the map data. For example, the host 102 may designate and request a portion of the map data, in which data needed to drive the data processing system 100, such as a file system, a boot image, and an operating system, is stored. As another example, the host 102 may request map data from the controller 130 without any designation.

In S611, the controller 130 may read a first portion MAP_M_1 of the memory map data MAP_M from the memory device 150. In S621, the first portion MAP_M_1 may be stored in the controller 130 as the controller map data MAP_C. In S631, the controller 130 may transmit the first portion MAP_M_1, which is stored as the controller map data MAP_C, to the host 102. The first portion MAP_M_1 may be stored in the host memory 106 as the host map data MAP_H.

In S612, the controller 130 may read a second portion MAP_M_2 of the memory map data MAP_M from the memory device 150. In S622, the second portion MAP_M_2 may be stored in the controller 130 as the controller map data MAP_C. In S632, the controller 130 may transmit the second portion MAP_M_2, which is stored as the controller map data MAP_C, to the host 102. The second portion MAP_M_2 may be stored in the host memory 106 as the host map data MAP_H, by the host 102.

The process continues in this sequence. Thus, in 561n, the controller 130 may read an n^{th} portion MAP_M_n of the memory map data MAP_M from the memory device 150. In 562n, the n^{th} portion MAP_M_n may be stored in the controller 130 as the controller map data MAP_C. In 563n, the controller 130 may transmit the n^{th} portion which is stored as the controller map data MAP_C, to the host 102. The n^{th} portion MAP_M_n may be stored in the host memory 106 as the host map data MAP_H, by the host 102. Consequently, the host 102, the controller 130, and the memory device 150 may complete initialization upload of the map data.

The controller 130 in FIG. 6 downloads a part of the memory map data MAP_M a plurality of times and uploads the downloaded memory map data MAP_M to the host 102 a plurality of times in response to a single request of map data received from the host 102 in S610. However, the controller 130 may upload all of the memory map data MAP_M to the host 102 in response to a single request of map data received from the host 102. Alternatively, the controller 130 may upload the memory map data MAP_M to the host 102 in parts or pieces in succession in response to respective requests from the host 102.

As described above, the controller map data MAP_C is stored in the memory 144 of the controller 130, and the host map data MAP_H is stored in the host memory 106 of the host 102.

If the initialization uploading of the map data is completed, the host 102 may cooperate with the memory system 110 and start accessing the memory system 110. An example is illustrated in FIG. 6 as the host 102 and the memory system 110 perform the initialization upload. However, the present invention is not limited to that specific configuration or processing. For example, the initialization upload may be omitted. The host 102 may gain access to the memory system 110 without the initialization upload.

After the map data initial uploading operation, uploading and updating the memory map data MAP_M may be performed in response to a host request or may be performed under the control of the controller 130 without a host request. The uploading and updating operation of the memory map data MAP_M may be performed in part or in whole, and may be performed at different times, e.g., periodically.

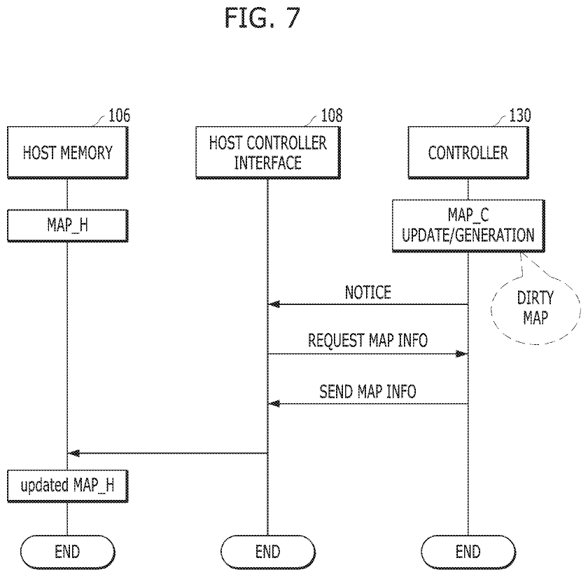

FIG. 7 is a block diagram illustrating an example of the map update operation performed by the data processing system illustrated in FIG. 5. Particularly, FIG. 7 illustrates a process of periodically uploading memory map data MAP_M to the host 102, and updating the host map data MAP_H which is metadata stored in the host memory 106, under the control of the controller 130.

The memory system 110 operably engaged with the host 102 may perform a read operation, an erase operation and a write operation of data requested by the host 102. After performing the read, erase and write operations of the data requested by the host 102, the memory system 110 may update the metadata when a change in the position of the data in the memory device 150 occurs.

The memory system 110 may update the metadata in response to such change in a process of performing a background operation, for example, a garbage collection operation or a wear-leveling operation, even without the request of the host 102. The controller 130 in the memory system 110 may detect whether the metadata is updated through the above-described operation. In other words, the controller 130 may detect that the metadata has become dirty (i.e., dirty map) while the metadata is generated, updated, erased, etc., and reflect the dirty map in dirty information.

When the metadata gets dirty, the controller 130 transmits a notice, informing a host controller interface 108 of the need to update the host map data MAP_H, to the host controller interface 108. In this case, the notice may be periodically transmitted at regular time intervals or transmitted according to how dirty the metadata has become.

In response to the notice received from the controller 130, the host controller interface 108 may transmit a request for the host map data MAP_H that needs to be updated, to the controller 130 (i.e., request map information). In this case, the host controller interface 108 may designate and request only a portion of the host map data MAP_H that needs to be updated or request all of the host map data MAP_H.

The controller 130 may transmit the metadata, that needs to be updated, in response to the request of the host controller interface 108 (i.e., transmit map information). The host controller interface 108 may transmit the transmitted metadata to the host memory 106, and update the stored host map data MAP_H (i.e., L2P map update).

The memory map data MAP_M stored in the memory device 150 may include mapping information between the physical address PA and the logical address LA of the nonvolatile memory element in the memory device 150 where MAP_M is stored. The memory map data MAP_M may be managed in units of map segments MS. Each of the map segments MS may include a plurality of entries, and each of the entries may include mapping information between consecutive logical addresses LA and consecutive physical addresses PA.

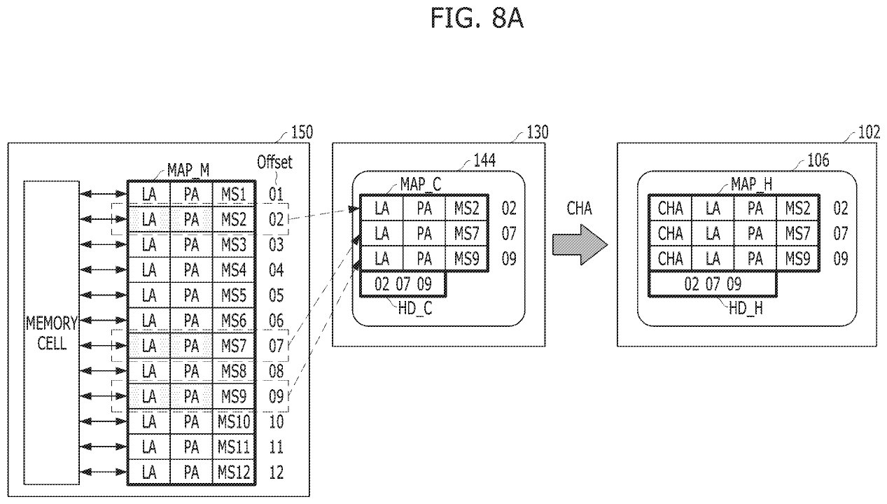

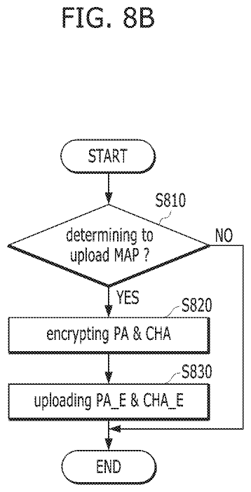

FIGS. 8A and 8B illustrates a method for encrypting map data. FIGS. 9A and 9D illustrates a method for generating version information of map data. With reference to FIGS. 5, 8A to 9D, a method of managing memory map data MAP_M in a memory device 150, controller map data MAP_C in a controller 130, and host map data MAP_H in a host 102, respectively will be described.

Referring to FIGS. 5 and 8A, the memory map data MAP_M stored in the memory device 150 may include L2P mapping information between physical addresses PA of a non-volatile memory element in the memory device 150 and logical addresses LA of the host 102. The memory map data MAP_M may be managed in units of a map segment MS.

Each L2P map segment MS include a certain number of mapping information items including the logical addresses and the physical addresses assigned to the logical addresses. Offsets(Index) may be assigned to the L2P map segments MS, respectively. For example, the offsets 01 to 12 may be assigned to the L2P map segments MS are, respectively.

The controller 130 may read the memory map data MAP_M from the memory device 150 in units of the L2P map segments MS and store the read memory map data MAP_M as the controller map data MAP_C. The controller 130 may generate a header HD_C when the controller map data MAP_C is stored. The header HD_C may include offsets of map segments MS stored as the controller map data MAP_C in the controller 130.

The controller 130 may generate a character CHA. The character CHA is information for checking or preventing hacking or loss of data of the map data while the host 102 and the controller 130 are transmitting/receiving the L2P map segment MS.

In an embodiment of the present invention, the transmitting/receiving processes of the L2P map segment MS between the host 102 and controller 130 may include uploading the controller map data MAP_C to the host 102 and downloading a physical address PA with an unmap request from the host 102. The controller 130 may generate the character CHA by performing AES (Advanced Encryption Standard)-based encryption, a hash function, or scrambling with respect to the logical address LA and the physical address PA of each L2P map segment MS in the controller map data MAP_C. The controller 130 may upload the character CHA with the L2P map segments MS of the controller map data MAP_C to the host 102.

The host 102 may store the L2P map segments MS of the controller map data MAP_C including the characters CHA from the controller 130 as the host map data MAP_H in the host memory 106. The host 102 may generate a header HD_H when the host map data MAP_H is stored. The header HD_H may include offsets of map segments MS stored as the host map data MAP_H.

According to an embodiment of the present invention, the host 102 may transmit a map request with an offset of a desired L2P map segment MS to the controller 130. Also, when a L2P map segment MS is received from the controller 130, the host 102 may compare an offset of the L2P map segment MS received from the controller 130 with an offset in the header HD_H. The host 102 may newly add the received L2P map segment MS from the controller 130 in the host map data MAP_H, or may change an old portion of the host map data MAP_H with the received L2P map segment MS, based on the comparison result.

According to an embodiment of the present invention, the host 102 may transmit an unmap request with at least one of a physical address, mapping information including a logical address and a physical address mapped to the logical address, or an offset of the mapping information, referring to the host map data MAP_H.

The controller 130 may determine whether a L2P map segment MS is stored in the controller map data MAP_C or not, by comparing the offset from the host 102 with an offset in the header in the controller map data MAP_C.

According to an embodiment of the present invention, a size of a space of the host memory 106 assigned to store the host map data MAP_H may be smaller than or equal to a size of the memory map data MAP_M. Also, the size of a space of the host memory 106 assigned to store the host map data MAP_H may be greater than or equal to a size of the controller map data MAP_C. When the size of the space assigned to the host map data MAP_H is smaller than the size of the memory map data MAP_M, the host 102 may select a release policy of the host map data MAP_H.

According to an embodiment of the present invention, when the storage space assigned to the host map data MAP_H is insufficient to store a new L2P map segment MS, the host 102 may discard a portion of the host map data MAP_H based on an Least Recently Used (LRU) policy or a Least Frequently Used (LFU) policy.

According to an embodiment of the present invention, when the memory map data MAP_M of the memory device 150 is updated due to garbage collection or wear leveling, the controller 130 may transmit the updated portion to the host 102. The host 102 may invalidate an old portion of the host map data MAP_H corresponding to the updated portion.

FIG. 8B is a flowchart illustrating an example in which the controller 130 performs encryption when transmitting the controller map data MAP_C to the host 102. Referring to FIGS. 5 and 8B, in operation S810, the controller 130 determines whether to transmit a physical address PA or a L2P map segment MS of the controller map data MAP_C to the host 102. In the case where neither the physical address PA nor the L2P map segment MS is sent to the host 102, operation S820 and operation S830 are omitted. In the case of transmitting the physical address PA or the L2P map segment MS to the host 102, operation S820 and operation S830 are performed.

In operation S820, the controller 130 may encrypt the physical address PA and a character CHA or encrypt physical addresses PA and signatures SIG of the L2P map segment MS. In operation S830, the controller 130 may transmit the encrypted physical address PA_E and the encrypted character CHA_E or the L2P map segment MS including the encrypted physical address PA_E and the encrypted character CHA_E to the host 102.

Although not shown in FIG. 8B, when the logical address LA, the encrypted physical address PA_E, and the encrypted character CHA_E are received from the host 102, the controller 130 determines a validity of the encrypted physical address PA_E by decrypting the encrypted physical address PA_E and the encrypted character CHA_E. The controller 130 may perform an unmap operation on the valid physical address PA. As described above, if a portion of the controller map data MAP_C loaded as host map data MAP_H on the host memory 106 of the host 102 is encrypted, the security level of the controller map data MAP_C and the memory device 150 may be improved.

FIG. 9A shows an example of assigning version information VN to controller map data MAP_C and host 102 map data MAP_H. Referring to FIGS. 5 and 9B, in operation S910, the controller 130 may receive a write request WT_REQ with a logical address from a host 102.

In operation S920, the controller 130 may perform a write operation to a free storage space of the memory device 150 in response to the write request WT_REQ. The controller 130 may generate a L2P map segment MS according to the performed write operation and may store the generated L2P map segment MS as a portion of the controller map data MAP_C. For example, the controller 130 may map the logical address corresponding to the write request WT_REQ to a physical address of the free storage space of the memory device 150. The controller 130 may add the mapping information to the controller map data MAP_C as the L2P map segment MS or may update the controller map data MAP_C with the mapping information.

In operation S930, the controller 130 may determine whether the L2P map segment MS is updated. For example, when a L2P map segment MS of the logical address corresponding to the write request WT_REQ is previously stored in the controller map data MAP_C or the memory map data MAP_M and the previously stored L2P map segment MS is changed according to the write request WT_REQ, the controller 130 may determine that the L2P map segment MS is updated. when the L2P map segment MS of a logical address corresponding to the write request WT_REQ is not previously stored in the controller map data MAP_C or the memory map data MAP_C, the L2P map segment MS corresponding to the write request WT_REQ is newly generated. Accordingly, the controller 130 may determine that the L2P map segment MS is not updated.

In other words, when a write request WT_REQ is a request for updating write data previously written in the memory device 150 or when the write request WT_REQ is an update request for a logical address at which write data is previously stored, the controller 130 may determine that a L2P map segment MS is updated. When a write request WT_REQ is a new write request WT_REQ associated with the memory device 150 or when the write request WT_REQ is a write request WT_REQ for a logical address at which write data is not previously stored, the controller 130 may determine that a L2P map segment MS is not updated.

If it is determined that the L2P map segment MS is updated, in operation S940, the controller 130 updates version information VN of the updated L2P map segment MS. For example, when a L2P map segment MS is stored in the controller 130, the controller 130 may update the version information VN. The updating of the version information VN may include increasing a count value of the version information VN. When a L2P map segment MS is stored in the memory device 150, the controller 130 may read the L2P map segment MS from the memory device 150 and may update version information VN of the read L2P map segment MS. If it is determined that the L2P map segment MS is not updated, the controller 130 maintains the version information VN of the L2P map segment MS without change.

FIG. 9B shows an example in which version information VN is added to the controller map data MAP_C and the host 102 map data MAP_H. Referring to FIGS. 5 and 9B, version information VN may be added to each L2P map segment MS of the controller map data MAP_C and each L2P map segment MS of the host 102 map data MAP_H.

For example, state values of version information VN of L2P map segments MS that respectively correspond to offsets “02”, “07”, and “09” of the controller map data MAP_C may be V1, V1, and V0. Also, state values of version information VN of L2P map segments MS that respectively correspond to offsets “02”, “07”, and “09” of the host 102 map data MAP_H may be V0, V1, and V0.

As described with reference to FIG. 9A, version information VN is updated whenever the controller map data MAP_C is updated.

That is, when a L2P map segment MS having the offset “02” is updated (e.g., a write operation is performed to a physical address PA corresponding to the L2P map segment MS having the offset “02”) the version information VN of the L2P map segment MS having the offset “02” is updated from ‘V0’ to ‘V1’, too.

However, if the updated L2P map segment MS having the offset “02” is not uploaded to the host 102 map data MAP_H, the version information ‘V1’ of a L2P map segment MS having the offset “02” of the controller map data MAP_C is greater than the version information ‘V0’ of a L2P map segment MS having offset “02” of the host 102 map data MAP_H. On the basis of the version information VN, the controller 130 may determine whether a physical address PA received from the host 102 is the latest or a physical address PA stored as the controller map data MAP_C is the latest.

FIG. 9C shows an example in which the controller map data MAP_C is uploaded to the host 102 map data MAP_H. Referring to FIGS. 5 and 9C, when the controller map data MAP_C is transmitted to the host 102 map data MAP_H, the physical address PA and the version information VN V1 of a L2P map segment MS having the offset “02” of the host 102 map data MAP_H become the same as the physical address PA and the version information VN V1 of a L2P map segment MS having the offset “02” of the controller map data MAP_C.

FIG. 9D shows an example in which version information VN is updated according to a time period. In FIG. 9D, the horizontal axis represents time, and the vertical axis shows L2P map segments MS loaded on the controller 130 as the controller map data MAP_C. According to an embodiment of the invention, state values of version information VN of L2P map segments MS respectively corresponding to offsets “01” to “12” are V0 and L2P map segments MS having the offset “08” and “11” are updated.

Referring to a first period, a first write operation WT1 and a second write operation WT2 may be performed on a physical address PA included a L2P map segment MS having the offset “08” and “11”, respectively.

The first write operation WT1 may program write data in the memory device 150 and update all or part of the L2P map segment MS having the offset “08” of the controller map data MAP_C. Accordingly, version information VN of the offset “08” may be updated from “V0” to “V1”. The second write operation WT2 may program write data in the memory device 150 and update all or part of the L2P map segment MS having the offset “11” of the controller map data MAP_C. Accordingly, version information VN of the offset “11” may be updated from “V0” to “V1”.

After the first period ends, the updated L2P map segments MS having the offsets “08” and “11” in the controller map data MAP_C may be uploaded to the host 102. Accordingly, the L2P map segments MS having the offsets “08” and “11” in the host 102 map data MAP_H have Version information VN of ‘V1’.

In a second period, a third write operation WT3 may program write data in the memory device 150 and update all or part of the L2P map segment MS having the offset “08” of the controller map data MAP_C. Accordingly, version information VN of the offset “08” may be updated from “V1” to “V2”. However, the L2P map segment MS having the offset “08”, on which the third write operation WT3 is performed, is not uploaded to the host 102 map data MAP_H. The version information ‘V2’ of a L2P map segment MS having the offset “08” of the controller map data MAP_C is more recent than the version information ‘V1’ of a L2P map segment MS having offset “08” of the host 102 map data MAP_H.

In the second period, an unmap request with a physical address PA and version information VN is received from the host 102. The physical address PA received from the host 102 may be a physical address PA included a L2P map segment MS having the offsets “11”. Since the L2P map segment MS having the offset “11” was already uploaded to the host 102 after the first period ends, the version information VN received from the host 102 is the same as version information VN of a L2P map segment MS having the offset “11” of the controller map data MAP_C. Accordingly, the controller 130 may determine that the physical address PA received from the host 102 is valid. Accordingly, the controller 130 may perform an unmap operation on the valid physical address PA received from the host 102.

In a third period, an unmap request with a physical address PA and version information VN is received from the host 102. The physical address PA received from the host 102 may be a physical address PA included a L2P map segment MS having the offsets “08”. Since the L2P map segment MS having the offset “08” is not uploaded to the host 102 after the third write operation WT3 is performed, the version information VN received from the host 102 is different from the version information VN of a L2P map segment MS having the offset “08” of the controller map data MAP_C. Accordingly, the controller 130 may determine that the physical address PA received from the host 102 is invalid.

Accordingly, the controller 130 may ignore a physical address PA received from the host 102.

The controller 130 may convert a logical address LA received from the host 102 into a physical address PA by using the L2P map segment MS having the offset “08” of the controller map data MAP_C.

As described above, the controller 130 may not update version information VN whenever a L2P map segment MS of the controller map data MAP_C is updated, but it may update version information VN of a L2P map segment MS in which one or more update operations are performed during a specific time period. Accordingly, it may be possible to use version information VN more efficiently and to reduce overhead of the controller 130 that manages the version information VN.

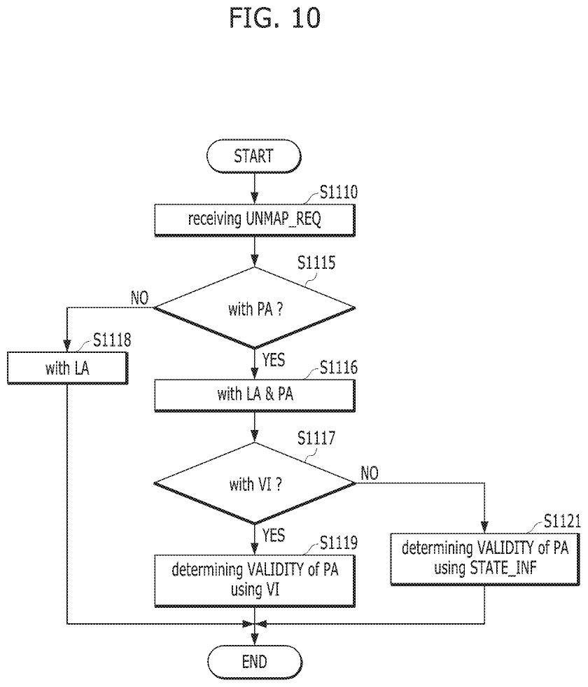

FIG. 10 is a flowchart illustrating a method to determine a validity of a physical address received with an unmap request from the host 102 in accordance with an embodiment.

The unmap request UNMAP_REQ may be for releasing a relation between a logical address and a physical address corresponding thereto. The unmap request UNMAP_REQ may include a sanitize request, an erase request, a delete request, a discard request and a format request. They are requests for releasing or de-mapping a relation between a logical address LA and a physical address PA of data stored in the memory device 150.

When the unmap request UNMAP_REQ is received from the host 102 in S1110, the memory system 110 determines whether a physical address PA is received together with the unmap request UNMAP_REQ and a logical address LA or not, in S1115.

When the physical address PA is not received from the host 102 (“NO” in S1115), the memory system 110 may determine that only a logical address LA is received together with the unmap request UNMAP_REQ. The memory system 110 may search for a physical address, in L2P map information corresponding to the received logical address LA stored in the memory system 110, and may perform an unmap operation on at least one of the physical address PA found in the search or the received logical address LA.

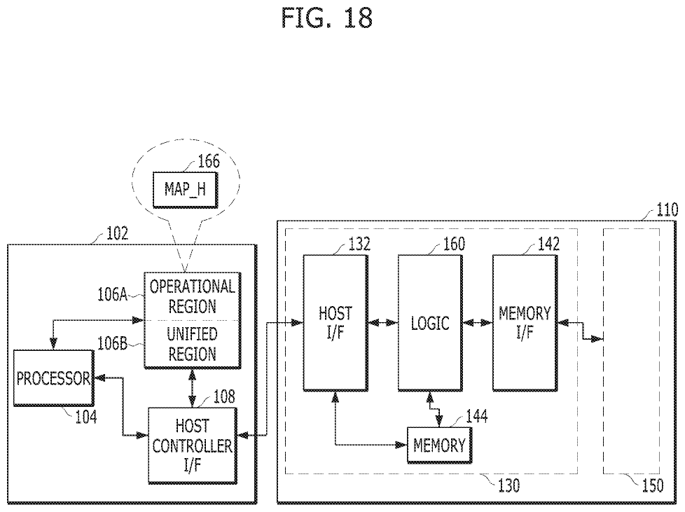

When the physical address PA is not received from the host 102 (“NO” in S1115), the memory system 110 may request L2P map data relating to the unmap request UNMAP_REQ to the host 102. The memory system 110 may perform the unmap operation on the physical address PA included in the L2P map data received from the host 102. An embodiment of the present invention in this regard will be described in detail with reference to FIGS. 18 to 20.

When the physical address PA is received from the host 102 (“YES” in S1115), the memory system 110 determines whether or not verification information VI is received together with the unmap request UNMAP_REQ and the physical address PA, in S1117.

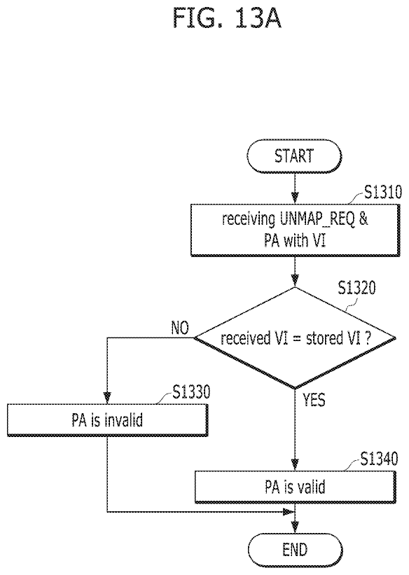

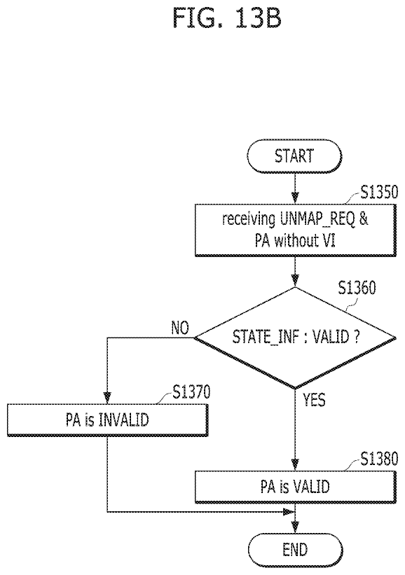

When the verification information VI is received from the host 102 (“YES” in S1117), the memory system 110 determines a validity of the physical address PA, using the verification information VI in S1119. An embodiment related to this configuration will be described below with reference to FIG. 13A.

When the verification information VI is not received from the host 102 (“NO” in S1117), the memory system 110 determines a validity of the physical address PA, using a state information STATE_INF stored in the memory 144, in S1121. An embodiment related to this configuration will be described below with reference to FIG. 13B. The state information STATE_INF may indicate states of map data. That is, the state information STATE_INF may indicate states of a physical address or a logical address.

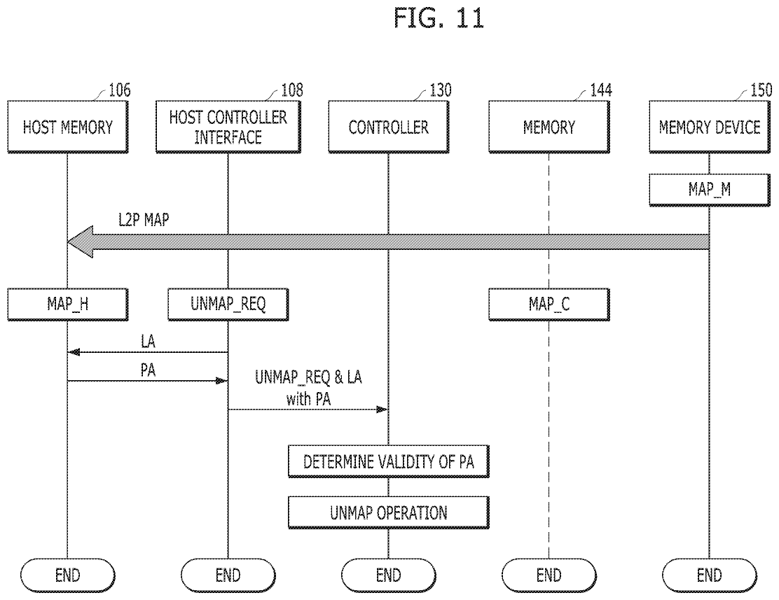

FIG. 11 illustrates a method of an unmap operation performed by a data processing system in accordance with an embodiment.

Referring to FIGS. 5 and 11, the host 102 includes a host memory 106 and a host controller interface 108, and host map data MAP_H is stored in the host memory 106.

When power is supplied to the host 102 and the memory system 110 (“power-on” of FIG. 6), the host 102 and the memory system 110 may communicate with each other. The controller 130 may load memory map data MAP_M, for example, L2P MAP, stored in the memory device 150.

The controller 130 may store the loaded memory map data MAP_M, i.e., L2P MAP, as controller map data MAP_C, in the memory 144. The controller 130 may upload the controller map data MAP_C, stored in the memory 144, to the host 102.

The host 102 may receive the controller map data MAP_C from the controller 130, and store the controller map data MAP_C, as the host map data MAP_H, in the host memory 106.

Although the memory 144 illustrated in FIGS. 1, 2 and 5 is a cache/buffer memory disposed within the controller 130, the memory 144 illustrated in FIGS. 11 to 20 is indicated as being external to the controller 130. Even with this arrangement, the memory 144 is used as a cache/buffer memory of the controller 130.

When the unmap request UNMAP_REQ is generated by the processor in the host 102, the generated unmap request UNMAP_REQ is transmitted to the host controller interface 108. The host controller interface 108 receives the unmap request UNMAP_REQ from the processor 104, and then transmits the logical address LA, corresponding to the unmap request UNMAP_REQ, to the host memory 106. The host controller interface 108 may recognize the physical address PA corresponding to the logical address LA, based on the meta data L2P MAP included in the host map data MAP_H stored in the host memory 106.

The host controller interface 108 transmits the unmap request UNMAP_REQ, together with the logical address LA and the physical address PA, to the controller 130. The controller 130 determines validity of the physical address PA received with the unmap request UNMAP_REQ and the logical address LA.

In the present embodiment, the controller 130 determines the validity of the physical address PA received with the unmap request UNMAP_REQ and the logical address LA, using verification information VI or state information STATE_INF. The state information STATE_INF may represent the states of nonvolatile memory elements included in the memory device 150, and include dirty information DIRTY, unmap information UNMAP_INF, invalid address information INV_INF and valid page counter VPC, in the present embodiment.

When the verification information VI is not received from the host controller interface 108, the controller 130 may determine the validity of the physical address PA, using the state information STATE_INF stored in the memory 144. When the verification information VI is received from the host controller interface 108, the controller 130 may determine the validity of the physical address PA, using the verification information VI in the controller map data MAP_C.

The controller 130 may perform an unmap operation on the memory device 150 based on the received unmap request UNMAP_REQ and the valid physical address PA and the logical address LA.

Since the physical address PA is received from the host 102, a process of searching for the physical address PA corresponding the logical address LA may be omitted. Accordingly, the speed at which a process of performing the unmap operation on the memory system by the host 102 may be increased.

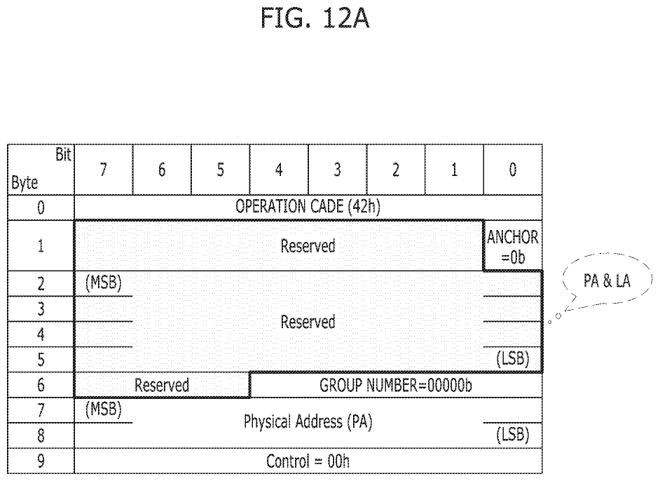

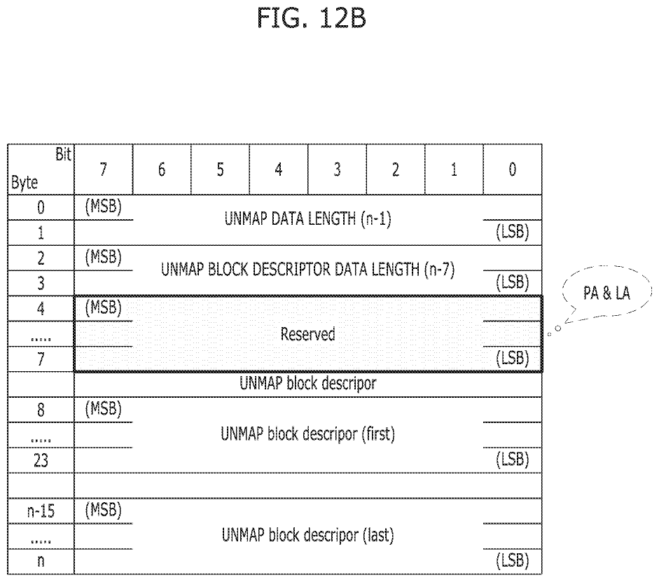

FIGS. 12A and 12B illustrate examples of an unmap command descriptor block and an unmap parameter list descriptor block of an unmap request, which are transmitted to the memory system 110 from the host 102.

Although FIGS. 12A and 12B illustrate the unmap command descriptor block and the unmap parameter list descriptor block of the unmap request UNMAP_REQ with reference to a command descriptor block of universal flash storage (UFS), the present invention is not limited thereto.

Each of the rows of the unmap command descriptor block illustrated in FIG. 12A includes each byte. For example, the rows may include zeroth to ninth bytes 0 to 9, respectively. In addition, each of the columns of the unmap command descriptor block includes a bit of each byte. For example, each of the bytes may include zeroth to seventh bits 0 to 7. The zeroth to seventh bits 0 to 7 of the zeroth byte 0 of the unmap command descriptor block may include an operation code. For example, the operation code of the unmap request UNMAP_REQ may be ‘42h’.

The first to the seventh bits 1 to 7 of the first byte 1 and the fifth to seventh bits 5 to 7 of the sixth byte 6 of the unmap command descriptor block may be reserved regions. The second to fifth bytes 2 to 5 of the unmap command descriptor block may be the reserved regions, and include the most significant bit MSB to the least significant bit LSB.

The seventh and eighth bytes 7 and 8 may include a parameter list length TRANSFER LENGTH. In addition, the ninth byte 9 may include a control CONTROL. For example, the control CONTROL may be ‘00h’.

In the present embodiment, the logical address LA and physical address PA, which become target for the unmap operation, may be included in the first to seventh bits 1 to 7 of the first byte 1, the fifth to seventh bits 5 to 7 of the sixth byte 6 and the second to fifth bytes 2 to 5, which are the reserved regions of the unmap command descriptor block illustrated in FIG. 12A. Also, the verification information VI may be further included therein.

In addition, in the present embodiment, only the physical address PA, which becomes a target for the unmap operation, may be included in the first to seventh bits 1 to 7 of the first byte 1, the fifth to seventh bits 5 to 7 of the sixth byte 6 and the second to fifth bytes 2 to 5, which are the reserved regions. Also, the verification information VI may be further included therein.

The unmap parameter list descriptor block of the unmap request UNMAP_REQ illustrated in FIG. 12B may be combined with the unmap command descriptor block illustrated in FIG. 12A, transmitted to the memory system 110, and include at least one of the logical address LA, the physical address PA and the verification information VI.

The fourth to seventh bytes 4 to 7 of the unmap parameter list descriptor block illustrated in FIG. 12B are the reserved regions, and the logical address LA, the physical address PA and the verification information VI may be included in the fourth to seventh bytes 4 to 7, which are the reserved regions.

When the verification information VI is not included in the unmap command descriptor block and the combination of the unmap command descriptor block and the unmap parameter list descriptor block, the memory system 110 according to the present embodiment may determine the validity of the physical address PA, using the state information STATE_INF stored in the memory 144.

When the verification information VI is included in the unmap command descriptor block and the combination of the unmap command descriptor block and the unmap parameter list descriptor block, the memory system 110 according to the present embodiment may determine the validity of the physical address PA, using any one of the state information STATE_INF and the verification information VI stored in the memory 144.

FIG. 13A is a flowchart illustrating a method for determining the validity of the physical address PA received from the host 102 using verification information VI.

Referring to FIG. 13A, the controller 130 may receive an unmap request UNMAP_REQ, a physical address PA corresponding to the logic address LA and verification information VI from a host 102. The host 102 may transmit a portion of host map data MAP_H including the logical address LA, the physical address PA relating to the unmap request UNMAP_REQ. The unmap request UNMAP_REQ may include the unmap request descriptor block and a combination of the unmap request descriptor block and the unmap parameter list descriptor block described above with reference to FIGS. 12A and 12B.

In S1320, the controller 130 determines whether the received verification information VI is the same as the verification information VI that is stored in the controller 130 and corresponds to the logical address LA.

When the received verification information VI is not the same as the verification information VI stored in the controller 130 (“NO” in S1320), the controller 130 determines the physical address PA received from the host 102 as an invalid address, in S1330.

When the received verification information VI is the same as the verification information VI stored in the controller 130 (“YES” in S1320), the controller 130 determines the physical address PA received from the host 102 as a valid address, in S1340.

The verification information VI may include a character CHA for determining whether or not the physical address PA is hacked, or whether some pieces of the physical address PA are lost, and version information VN for determining whether the L2P map data is the latest information. If the controller 130 determines that the host map data MAP_H has been hacked or that data loss has occurred in the host map data MAP_H, the controller 130 indicates that the host map data MAP_H is not valid, the controller 130 may inform to the host 102, through a response, that the physical address PA received in S1310 is not valid. When the received verification information VI is encrypted, the controller 130 may decrypt the verification information VI, and then perform the step S1320. Accordingly, the security of the physical address PA may be improved, and the security of the memory system may be improved as well.

When the version information VN is used as the verification information VI, the controller 130 may determine whether the physical address PA is the latest or not, in S1330. Accordingly, the controller 130 may inform the host 102, through the response, that the host map data MAP_H is not valid.

Since the validity of the physical address PA is determined using the verification information VI, the unmap operation may be performed on the physical address PA, which is in the latest state, without hacking and loss of data. Thus, the reliability of the unmap operation according to the present embodiment may be improved.

FIG. 13B is a flowchart illustrating a method for determining the validity of the physical address PA received from the host 102 using state information STATE_INF.

Referring to FIG. 133, the controller 130 may receive an unmap request UNMAP_REQ, a physical address PA corresponding to the logic address LA and verification information VI from a host 102 in S1350.

In S1360, the controller 130 may determine validity of the received the physical address PA by checking state information STATE_INF corresponding to the logical address LA or the physical address PA. In particular, the state information STATE_INF corresponding to the logical address LA may include dirty information DIRTY_INF or unmap information UNMMAP_INF. The state information STATE_INF corresponding to the physical address PA may include invalid address information INV_INF in S1360.

If the state information STATE_INF indicates that the logical address is unmapped or is dirty, or that the physical address is invalidated (“NO” in S1360), the controller 130 determines that the physical address PA received from the host 102 is an invalid address, in S1370.

If the state information STATE_INF indicates that the logical address is not unmapped and is not dirty, or that the physical address is not invalidated (“YES” in S1360), the controller 130 determines that the physical address PA received from the host 102 is a valid address, in S1380.

Since the validity of the physical address PA received from the host 102 is simply determined using the state information STATE_INF, the speed of the unmap operation may be improved.

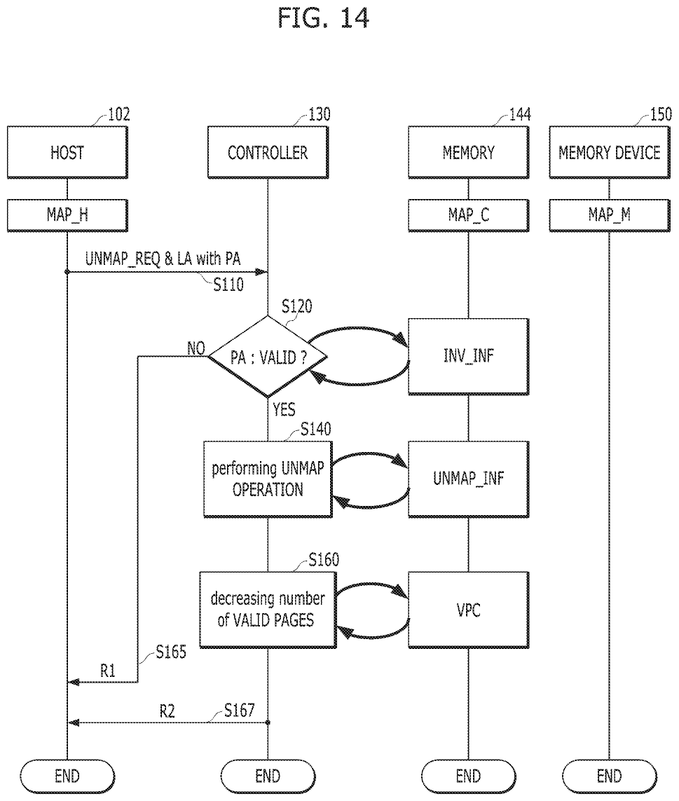

A method for performing the unmap operation by using state information, in accordance with an embodiment, is described below with reference to FIGS. 14 to 17.

Referring to FIG. 14, the memory system 110 may receive the physical address PA together with the unmap request UNMAP_REQ and the logical address LA from the host 102, in S110. The memory system 110 may determine a validity of the physical address PA received together with the unmap request UNMAP_REQ, in S120.

In the embodiment of FIG. 14, the controller 130 may determine the validity of the physical address PA using the invalid address information INV_INF. However, the present invention is not limited thereto. The controller 130 may determine validity of the received the physical address PA from the host 102 by checking state information STATE_INF corresponding to the logical address LA or the physical address PA. In particular, the state information STATE_INF corresponding to the logical address LA may include dirty information DIRTY_INF or unmap information UNMMAP_INF. The state information STATE_INF corresponding to the physical address PA may include invalid address information INV_INF.

When the physical address PA received from the host 102 is not valid (“NO” in S120), the controller 130 does not perform an unmap operation. Then, the controller 130 may transmit a first response R1 to the host 102 in S165. The first response R1 may include a message indicating that unmap operation is not performed. The first response R1 may further include a message indicating that the received physical address PA is not valid. After the host 102 receives the first response R1 from the controller 130, the host 102 may request map data MAP_C related to the logical address LA to the controller 130, to update the host map data MAP_H. Even without the request of the host 102, the controller 130 may upload the controller map data MAP_C to the host 102 and allow the host map data MAP_H related to the logical address LA to be updated. Subsequently, the host 102 may transmit the physical address based on the updated host map data MAP_H, together with the unmap request UNMAP_REQ, to the controller 130. Accordingly, the controller 130 may receive an unmap request UNMAP_REQ including the valid physical address PA from the host 102 in the future. Therefore, the reliability of the unmap operation may be improved.

When the physical address PA received together with the unmap request UNMAP_REQ is valid (“YES” in S120), the controller 130 may perform the unmap operation to the physical address PA for releasing or de-mapping a corresponding relation between the logical address LA and the valid physical address PA in S140.

The unmap operation is for releasing or de-mapping a relation between a logical address LA and a physical address PA corresponding to the logical address LA. That is, in the unmap operation the logical address LA is changed to an unallocated state to which no physical address is assigned. The unmap operation may be performed by invalidating the physical address currently assigned to the logical address.

To perform the unmap operation, the controller 130 changes a state value of the unmap information UNMMAP_INF corresponding to the logical address LA in S140. Accordingly, the controller 130 can recognize that the logical address has been unmapped, referring to the unmap information UNMMAP_INF. The controller 130 may change a state value of the invalid address information INV_INF corresponding to the physical address PA for invalidating the valid physical address PA in S140. Accordingly, the controller 130 can recognize that the physical address PA, which is mapped to the logical address that has been unmap-requested, has been invalidated, referring to the invalid address information INV_INF.

After performing the unmap operation, the controller 130 may change a valid page counter (VPC) for decreasing the number of valid pages included in a memory block, which corresponds to the invalidated physical address PA on which the unmap operation is performed in S160.

Then, the controller 130 may transmit a second response R2 to the host 102 in S167. The second response R2 may include a message indicating that unmap operation has been successfully performed. The second response R2 may further include a message indicating that the received physical address PA is valid.

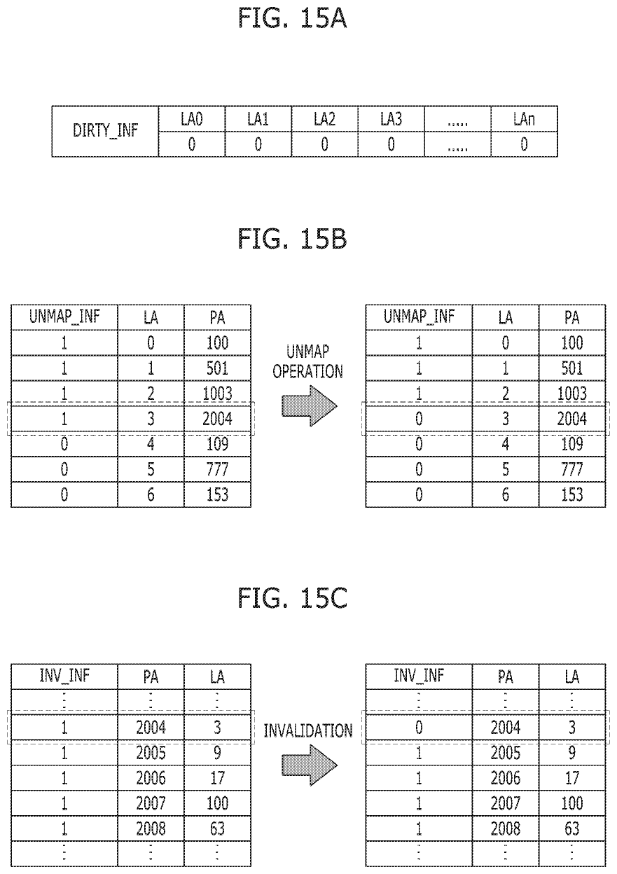

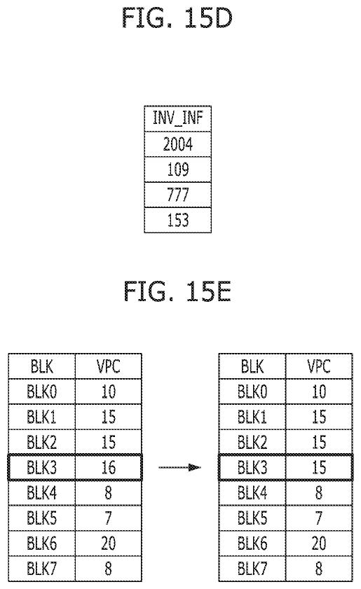

FIGS. 15A to 15E illustrate examples of the state information STATE_INF in accordance with an embodiment. The state information STATE_INF may include dirty information DIRTY_INF, unmap information UNMAP_INF, invalid address information INV_INF and valid page counter VPC, in the present embodiment. The state information may have a bitmap value. The state information has an initial value indicating a first level ‘0’ and is updated to a second level ‘1’. In this case, since the state information has less storage space in the memory 144, the controller 130 can access the state information without burden. The status information can be managed in units of map segments. The state information may have a counter value or be in a list form.

FIG. 15A illustrates an example of dirty information DIRTY_INF managed in bitmap. The dirty information DIRTY_INF may indicate whether or not a physical address corresponding to a logical address LA has changed, which is indicative of whether or not a storage location of the data corresponding to the logical address LA has changed. That is, the controller 130 may update the dirty information DIRTY_INF when the map data is updated.

FIG. 15B illustrates an example of unmap information UNMAP_INF managed in bitmap form. The unmap information UNMAP_INF may include map information about a logical address de-mapped from a physical address by performing an unmap operation.

FIG. 15C illustrates an example of invalid address information INVALID_INF managed in bitmap form. FIG. 15D illustrates an example of invalid address information INVALID_INF managed in list form. The invalid address information may include a physical address of an invalidation page. In an embodiment of the present invention, the invalid address information may include a physical address of a page where old write data that is invalidated is stored when a write operation is performed or where an unmap operation is performed.

FIG. 15E illustrates an example of valid page counter VPC managed in counter value. The valid page number may indicate the number of valid pages included in a memory block.

Assuming that a logical address LA “3” and a physical address PA “2004” are received with an unmap request from the host 102 in S110 of FIG. 14, the controller 130 checks a state value of the physical address PA “2004” in the invalid address information INV_INF. Referring to FIG. 15C, the state value corresponding to the physical address PA “2004” of the invalid address information INV_INF is “1”. The state value “1” may indicate that the corresponding physical address PA is a valid physical address, and the state value “0” may indicate that the corresponding physical address PA is an invalid physical address. Accordingly, the controller 130 may determine that the physical address PA “2004” is a valid physical address.

The controller 130 may perform the unmap operation on the logical address LA “3” and the valid physical address PA “2004”. To this end, the controller 130 may perform the unmap operation to the logical address LA “3” by changing the state value of the unmap information UNMAP_INF from “1” to “0” in FIG. 15B. Also, the controller 130 may invalidate the valid physical address PA “2004” by changing the state value of the invalid address information INV_INF from “1” to “0” in FIG. 15C.

When the unmap operation is performed, the controller 130 may not actually erase valid data stored in the physical address PA received together with the unmap request UNMAP_REQ. Rather, the controller 130 performs the unmap to just invalidate the physical address PA received from the host 102 or change the state information STATE_INF of the logical address LA corresponding to the physical address PA. Accordingly, the speed of performing the unmap operation may be improved, and the convenience of invalid data management may be increased.

Referring back to FIG. 14, after performing the unmap operation, the controller 130 may decrease the number of valid pages of a memory block corresponding to the invalidated physical address in invalid address information INV_INF in S160.

Referring to FIGS. 14 and 15E, when it is assumed that the invalidated physical address PA “2004” is a physical address of a page included in a fourth memory block BLK3, the controller 130 may invalidate the physical address PA “2004”, in S140, and then change a valid page count of valid page counter VPC in the fourth memory block BLK3 from “16” to “15”, in S160.

In the embodiment described above, the physical address PA received from the host 102 corresponds to one page. However, the present invention is not limited thereto. The physical address PA received from the host 102 may correspond to multiple pages. For example, when the physical address PA corresponds to five pages, the controller 130 may invalidate the physical address PA received together with the unmap request UNMAP_REQ, and then change the valid page counter VPC in the fourth memory block BLK3 corresponding to the five pages from “16” to “11”. In another scenario, when two pages among the five pages are in a first memory block BLK0, and the other three pages are in a second memory block BLK1, the controller 130 may change the valid page counter VPC in the first memory block BLK0 from “10” to “8”, and change the valid page counter VPC included in the second memory block BLK1 from “15” to “12”.

The controller 130 according to the present embodiment may perform a garbage collection operation on a memory block having a valid page count, as indicated by its valid page counter VPC, less than a set value. The controller 130 according to the present embodiment may perform an erase operation on a memory block having a valid page count of 0.

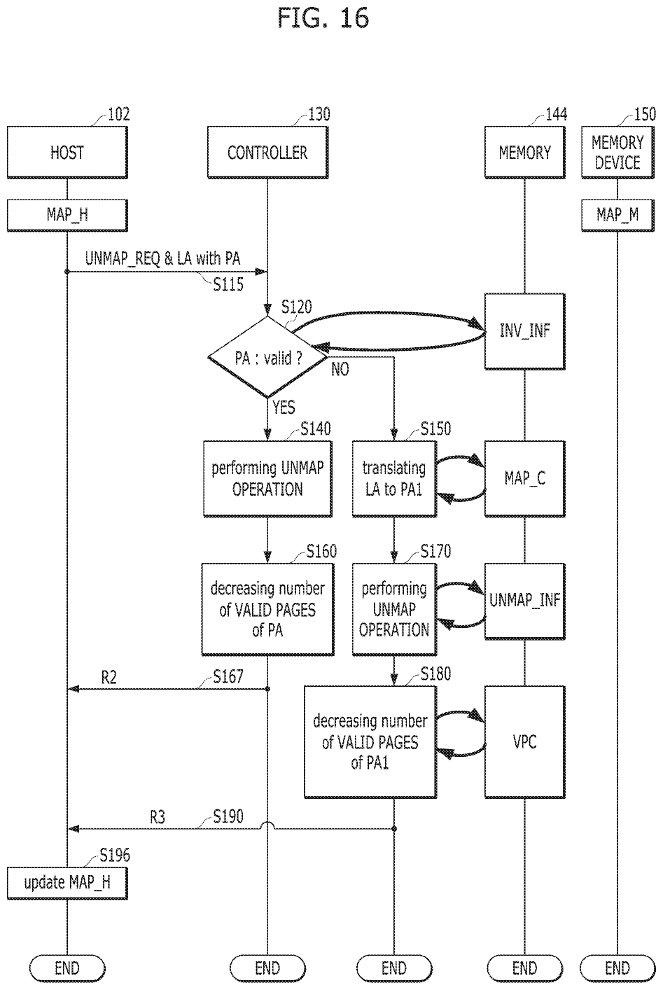

A method for performing the unmap operation in accordance with an embodiment is described with reference to FIG. 16. Particularly, FIG. 16 illustrates such method, based on features that can be technically distinguished from to the FIG. 14. The controller 130 illustrated in FIG. 14 does not perform an unmap operation when the physical address PA received with the unmap request UNMAP_REQ from the host 102 is not valid. However, the controller 130 illustrated in FIG. 16 performs an unmap operation by using map data stored in the memory 144 of the controller 130 when the physical address PA received with the unmap request UNMAP_REQ from the host 102 is not valid.

Referring to FIG. 16, When the physical address PA is not valid (“NO” in S120), the controller 130 reads a L2P map segment, corresponding to the logical address LA, in controller map data MAP_C. The controller 130 translates the logical address LA to a first physical address PA1 corresponding to the logical address LA in the controller map data MAP_C in S150.

In the present embodiment, when the physical address PA received from the host 102 is not valid, an address translation operation is performed to search for the valid first physical address PA1. Accordingly, the flexibility and reliability of the unmap operation may be improved because the unmap operation is performed on the valid first physical address PA1. Subsequently, the controller 130 may perform the unmap operation for releasing or de-mapping a corresponding relation between the logical address LA and the valid first physical address PA1 in S170. To perform the unmap operation, the controller 130 changes a state value of the unmap information UNMMAP_INF corresponding to the logical address LA. The controller 130 may further change a state value of the invalid address information INV_INF corresponding to the valid first physical address PA1.

By invalidating the first physical address PA1, valid data stored in the nonvolatile storage element corresponding to the first physical address PA1 may be invalidated. After the unmap operation is performed, the controller 130 decreases the count of the number of valid pages maintained by the VPC of the memory block corresponding to the first physical address PA1 in S180.

Subsequently, the controller 130 may transmit a third response R3 to the host 102 in S190. The third response R3 may include the first physical address PA1 and a message indicating that the unmap operation has been completely performed on the first physical address PA1. The host 102 may update host map data MAP_H according to the third response R3 received from the controller 130, in S196.

According to the present embodiment, since the valid first physical address PA1 is fed back to the host 102, the convenience and reliability of management of the host map data MAP_H may be improved. In addition, by updating the host map data MAP_H, the controller 130 may receive an unmap request UNMAP_REQ including the valid first physical address PA1 from the host 102 in the future. Therefore, the reliability of the unmapped operation may be improved.

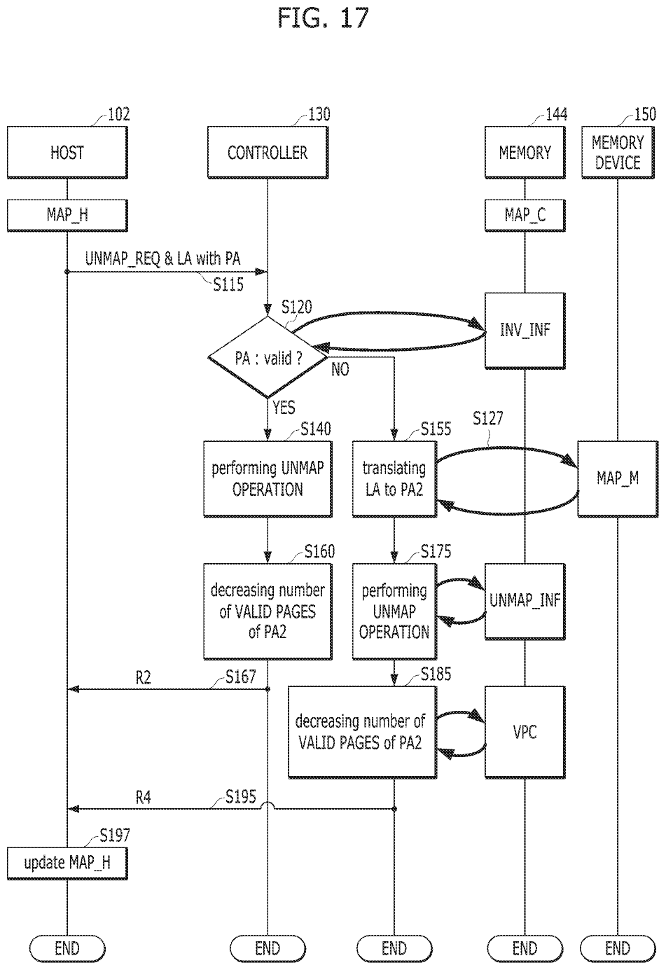

A method for performing the unmap operation in accordance with an embodiment is described with reference to FIG. 17. Particularly, FIG. 17 illustrates the method, based on features that can be technically distinguished from the FIGS. 14 and 16. The controller 130 illustrated in FIG. 14 does not perform an unmap operation when the physical address PA received with the unmap request UNMAP_REQ from the host 102 is not valid. However, the controller 130 illustrated in FIG. 17 performs an unmap operation by using map data stored in the memory device 150 when the physical address PA received with the unmap request UNMAP_REQ from the host 102 is not valid.

When the physical address PA received together with the unmap request UNMAP_REQ is not valid (“NO” in S120), the controller 130 reads a L2P map segment corresponding to the logical address LA, in a memory map data MAP_M. The controller 130 translates the logical address LA to a second physical address PA2 corresponding to the logical address LA, referring to the L2P map segment in S155.

Then, an address translation operation is performed to search for the valid first physical address PA2. Accordingly, the flexibility and reliability of the unmap operation may be improved because the unmap operation is performed on the valid first physical address PA2. Subsequently, the controller 130 may perform the unmap operation for releasing or de-mapping a corresponding relation between the logical address LA and the valid first physical address PA1 in S175. To perform the unmap operation, the controller 130 changes a state value of the unmap information UNMMAP_INF corresponding to the logical address LA. The controller 130 may further change a state value of the invalid address information INV_INF corresponding to the valid first physical address PA2.

By invalidating the first physical address PA2, valid data stored in the nonvolatile storage element corresponding to the first physical address PA2 may be invalidated. After the unmap operation is performed, the controller 130 decreases the number of valid pages of the VPC of the memory block corresponding to the first physical address PA2 in S185.

In S195, the controller 130 may transmit a fourth response R4. The fourth response R4 may include the second physical address PA2 and a message indicating that the unmap operation has been completely performed on the second physical address PA2. The host 102 may update host map data MAP_H according to the fourth response R4 received from the controller 130, in S197.

According to the present embodiment, since the valid second physical address PA2 is fed back to the host 102, the convenience and reliability of management of the host map data MAP_H may be improved. In addition, according to the present embodiment, as the host 102 receives the valid second physical address PA2 from the controller 130, and updates the host map data MAP_H, the controller 130 may receive the unmap request UNMAP_REQ including the valid second physical address PA2 from the host 102 in the future. Therefore, the reliability of the unmapped operation may be improved.

In addition, according to the present embodiment, when the physical address PA received from the host 102 is not valid, the controller 130 may load only the physical address PA corresponding to the logical address LA received from the host 102 or an L2P segment corresponding to the logical address LA received from the host 102, instead of all of the memory map data MAP_M stored in the memory device 150. Therefore, the overhead of the memory system may be reduced, the lifespan of the memory system may be improved, and the speed of performing the unmap operation may be improved.

A method of operating the data processing system 100 and the memory system to perform an unmap operation according to another embodiment of the present disclosure is described with reference to FIGS. 18 to 20.

In particular, the data processing system and the memory system according to the embodiment of FIGS. 18 to 20 illustrate a method of performing an unmap operation using a logical address LA and metadata received from the host 102.

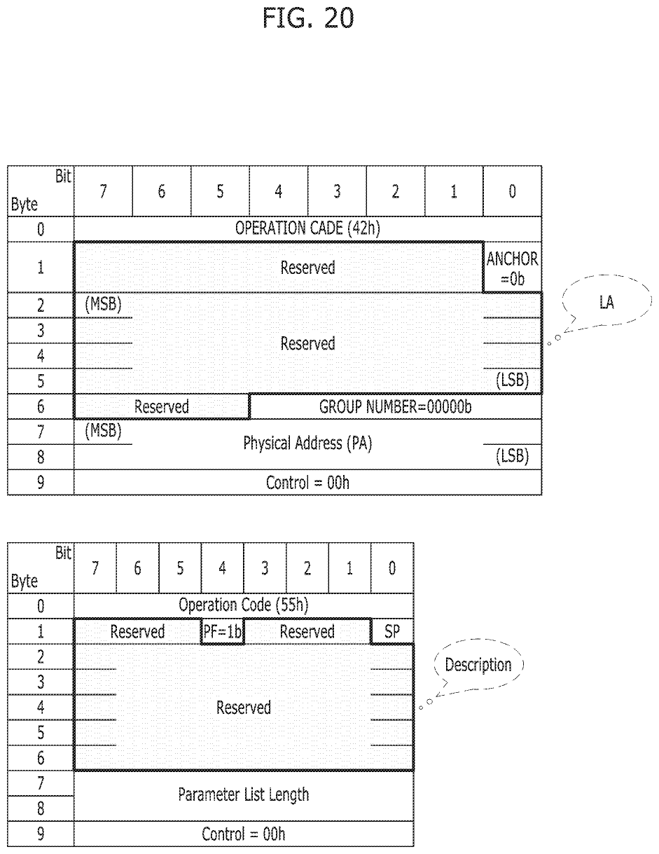

FIG. 20 illustrates an example of an unmap command descriptor block of an unmap request UNMAP_REQ including only a logical address LA generated by the host 102. FIG. 20 illustrates an example of command descriptor block (MCDB) of a mode select command generated by the host 102.

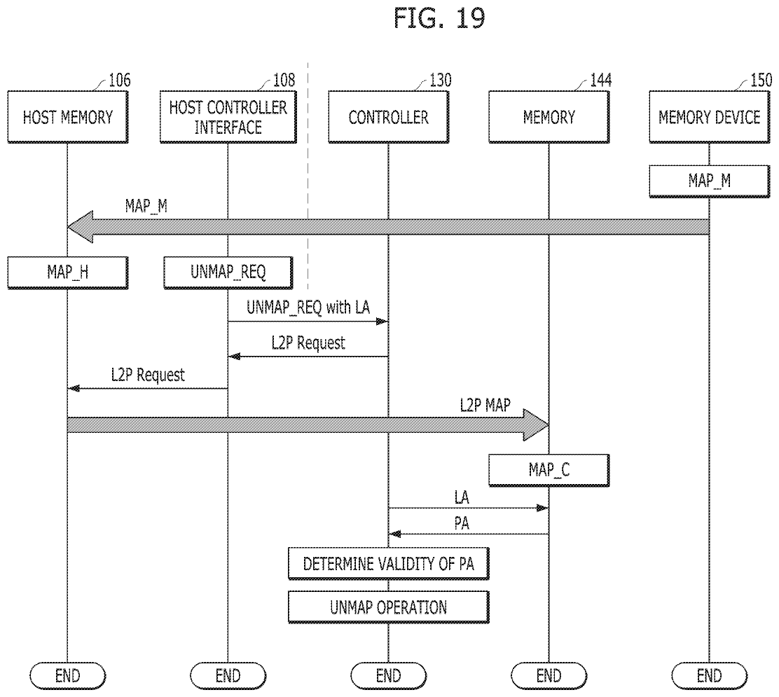

The configurations of the host 102 and the memory system 110 shown in FIGS. 18 and 19 may be similar to the host 102 and the memory system 110 described in FIG. 5. The host 102 and the memory system 110 illustrated in FIGS. 18 and 19 may be different than the host 102 and the memory system 110 of FIG. 5 in configuration, operation, or role.

In FIG. 5, the memory system 110 may use the host memory 106 included in the host 102 as a cache memory that stores the host map data MAP_H. In FIGS. 18 and 19, the memory system 110 may use the host memory 106 in the host 102 as a buffer for storing metadata (for example, a memory map data MAP_M) as well as user data.

Referring to FIG. 18, the host memory 106 may include an operational region 106A and a unified region 106B. The operational region 106A of the host memory 106 may be a space used by the host 102 to store data or signal in the course of performing an operation through the processor 104. The unified region 106B of the host memory 106 may be a space used to support an operation of the memory system 110, rather than that of the host 102. The host memory 106 may be used for another purpose depending on an operation time. Sizes of the operational region 106A and the unified region 106B may be dynamically determined. Because of these features, the host memory 106 may be referred to as a provisional memory or storage.

The unified region 106B may be provided by the host 102, allocating a portion of the host memory 106 for the memory system 110. The host 102 might not use the unified region 106B for an operation internally performed in the host 102 regardless of the memory system 110. In the memory system 110, a memory device 150 may include a nonvolatile memory that spends more time to read, write, or erase data than that of the host memory 106 in the host 102, which is a volatile memory. When a time spent or required to read, write or erase data in response to a request from the host 102 becomes long, latency may occur in the memory system 110 to continuously execute plural read and write commands from the host 102. Thus, in order to improve or enhance operational efficiency of the memory system 110, the unified region 106B in the host 102 may be utilized as a temporary storage of the memory system 110.

By way of example but not limitation, when the host 102 intends to write a large amount of data to the memory system 110, it may take a long time for the memory system 110 to program the large amount of data to the memory device 150. When the host 102 tries to write or read other data to or from the memory system 110, the associated write or read operation may be delayed because of the previous operation, i.e., it takes the long time for the memory system 110 to program the large amount of data into the memory device 150. In this case, the memory system 110 may request the host 102 to copy the large amount of data to the unified region 106B of the host memory 106 without programming such data into the memory device 150. Because the time required to copy data from the operational region 106A to the unified region 106B in the host 102 is much shorter than the time required for the memory system 110 to program the data to the memory device 150, the memory system 110 may avoid delaying the write or read operation associated with other data. Thereafter, the memory system 110 may transfer the data temporarily stored in the unified region 106B of the host memory 106 to the memory device 150, while the memory system 110 does not receive a command to read, write, or delete data from the host 102. In this way, a user might not experience slowed operation and instead may experience that the host 102 and the memory system 110 are handling or processing the user's requests at a high speed.

The controller 130 of the memory system 110 may use an allocated portion of the host memory 106 (e.g., the unified region 106B) in the host 102. The host 102 might not involve an operation performed by the memory system 110. The host 102 may transmit an instruction such as a read, a write, a delete or unmap with a logical address into the memory system 110. The controller 130 may translate the logical address into a physical address. The controller 130 may store metadata in the unified region 106B of the host memory 106 in the host 102 when storage capacity of the first memory 144 in the controller 130 is too small to load the metadata used for translating a logical address into a physical address. In an embodiment, using the metadata stored in the unified region 106B of the host memory 106, the controller 130 may perform address translation (e.g., recognize a physical address corresponding to a logical address received from the host 102).

For example, the operation speed of the host memory 106 and the communication speed between the host 102 and the controller 130 may be faster than the speed at which the controller 130 accesses the memory device 150 and reads data stored in the memory device 150. Thus, rather than loading metadata stored from the memory device 150 as needed, the controller 130 may quickly load the metadata from the host memory 106, as needed.

When metadata (L2P MAP) is stored in the host memory 106 of the host 102, an unmap operation requested by the host 102 may be performed as described with reference to FIGS. 18 through 20.

After power is supplied to the host 102 and the memory system 110, the host 102 and the memory system 110 may be operably engaged. When the host 102 and the memory system 110 cooperate, the metadata (L2P MAP) stored in the memory device 150 may be transferred into the host memory 106. Storage capacity of the host memory 106 may be larger than that of the first memory 144 used by the controller 130 in the memory system 110. Therefore, even if some or all of the metadata (L2P MAP) stored in the memory device 150 is entirely or mostly transferred into the host memory 106, it might not burden operations of the host 102 and the memory system 110. The metadata (L2P MAP) transmitted into the host memory 106 may be stored in the unified region 106B in FIG. 18.

As shown in FIGS. 18 to 20, an unmap request, which may be in the form of an unmap command, is issued by the processor 104 in the host 102, the unmap request may be transmitted to the host controller interface 108. The host controller interface 108 may receive a unmap request and then transmit the unmap request with a logical address to the controller 130 of the memory system 110 (UNMAP_REQ with LA).

As illustrated in FIG. 20, a logical address LA may be included in a reserved area of the unmap command descriptor block. The host controller interface 108 may transmit the logical address LA to the memory system 110.

When the first memory 144 does not include metadata relevant to the logical address entered from the host 102, the controller 130 in the memory system 110 may request from the host controller interface 108 the metadata corresponding to the logical address (L2P MAP Request).

As storage capacity of the memory device 150 increases, more of that capacity may be used to store logical addresses. For example, the capacity needed to store the range of logical addresses may depend on the storage capacity of the memory device 150. The host memory 106 may store metadata corresponding to most or all of the logical addresses, but the first memory 144 in the memory system 110 might not have sufficient space to store the metadata. When the controller 130 may determine that a logical address from the host 102 with the unmap request UNMAP_REQ may belong to a particular range (e.g., LBN120 to LBN600), the controller 130 may request the host controller interface 108 to transmit one or more metadata corresponding to the particular range (e.g., LBN120 to LBN600) or a larger range (e.g., LBN100 to LBN800). The host controller interface 108 may transmit the metadata requested by the controller 130 to the memory system 110. The transmitted metadata (L2P MAP) may be stored in the first memory 144 of the memory system 110.

The host controller interface 108 may transmit a corresponding portion of the metadata (L2P MAP) stored in the host memory 106 to the memory system 110 in response to the request of the controller 130.

In this case, the host controller interface 108 may include a part of the host map data MAP_H requested by the controller 130 in the descriptor block of the unmap parameter list illustrated in FIG. 12B and transmit the portion to the memory system 110. In addition, the host controller interface 108 may transfer the command descriptor block MCDB of the mode selection command illustrated in FIG. 20 to the memory system 110.

In this case, the reserved area of the command descriptor block MCDB of the mode selection command may include an argument or description for notifying transmission of the host map data MAP_H and the character CHA.

The memory system 110 may transmit a response including a ready to transfer “ready to transfer UPIU” including a message of ready to receive data to the host controller interface 108 in response to the command descriptor block MCDB of the mode selection command.

When a response is received from the memory system 110, the host controller interface 108 may transmit a data output UPIU including the host map data MAP_H and a character CHA to the memory system 110.

The host map data MAP_H transferred from the host controller interface 108 may be stored as the controller map data MAP_C in the memory 144 in the memory system 110.

The controller 130 may recognize the physical address PA corresponding to the logical address LA transmitted from the host 102 based on the controller map data MAP_C stored in the memory 144. The controller 130 may determine the validity of the physical address PA and use the same to perform an unmap operation on the memory device 150.

As described above, the host memory 106 is used as a buffer for storing metadata (L2P MAP) so that the controller 130 might not instantly read or store the metadata (L2P MAP) from the memory device 150. Accordingly, operational efficiency of the memory system 110 may be improved or enhanced.

As described above, the operational efficiency of the memory system 110 may be improved based on the different embodiments described with reference to FIGS. 10 to 17 and 18 to 20. The memory system 110 may use a portion of the host memory 106 included in the host 102 as a cache or a buffer, and store meta data or user data, thereby overcoming a limitation in the storage space of the memory 144 used by the controller 130 in the memory system 110.

The effects of the memory system, the data processing system and the driving method thereof according to embodiments of the present invention are as follows.

According to embodiments, the overhead of the memory system can be reduced, and the lifespan of the memory system and the speed of performing the unmap operation can be improved.

According to embodiments, the speed of performing the unmap operation can be improved, and the convenience of invalid data management can be increased.

According to embodiments, the efficiency of the erase operation can be improved.

According to embodiments, the manufacturing cost can be decreased while increasing the operational efficiency.

According to embodiments, the reliability of the memory system can be improved.

According to embodiments of the disclosure, a data processing system and a method of operating the data processing system may avoid or reduce delay in data transmission, which occurs due to a program operation verification in a process of programming a large amount of data in the data processing system to a nonvolatile memory block, thereby improving data input/output (I/O) performance of the data processing system or a memory system thereof.

While the present invention has been illustrated and described with respect to specific embodiments, it will be apparent to those skilled in the art that various changes and modifications may be made without departing from the spirit and scope of the invention as defined in the following claims. The present invention encompasses all such changes and modifications that fall within the scope of the claims including their equivalents.

What is claimed is:

1. A memory system comprising:
a memory device comprising a plurality of memory elements, and suitable for storing L2P map data; and
a controller suitable for:
controlling the memory device by storing at least a portion of the L2P map data and state information of the L2P map data,
determining validity of a first physical address received together with an unmap request from an external device, and
performing an unmap operation on the first physical address, when it is determined to be valid.

2. The memory system of claim 1, wherein the unmap operation comprises changing a value of state information corresponding to the valid first physical address or a logical address mapped to the valid first physical address, in order to invalidate the valid first physical address.

3. The memory system of claim 2, wherein the state information comprises invalid address information, dirty information and unmap information.

4. The memory system of claim 1, wherein the controller decreases a count of a number of valid pages of a memory block corresponding to the first physical address after performing the unmap operation.

5. The memory system of claim 4, wherein the controller performs a garbage collection operation on a memory block having a number of valid pages less than a set number.

6. The memory system of claim 4, wherein the controller performs an erase operation on a memory block having no valid page.

7. The memory system of claim 1, wherein the unmap request comprises a discard command and an erase command.

8. The memory system of claim 1, wherein the controller determines the validity of the first physical address using the state information.

9. The memory system of claim 1, wherein, when the first physical address is not valid, the controller searches the L2P map data for a valid second physical address corresponding to a logical address received from the external device, and performs the unmap operation on the valid second physical address found in the search.

10. The memory system of claim 1, wherein the L2P map data stored in the controller comprises first verification information generated based on an encryption of the L2P map data and second verification information generated based on an update version of the L2P map data.

11. The memory system of claim 10, wherein the controller determines the validity of the first physical address using the first verification information or the second verification information.

12. A data processing system comprising:
a memory system suitable for storing L2P map data of a plurality of memory elements; and
a host suitable for storing at least a portion of the L2P map data, and transmitting an unmap request and a target physical address of the unmap request to the memory system,
wherein the memory system determines validity of the target physical address, and performs an unmap operation on the target physical address, when it is determined as valid.

13. The data processing system of claim 12, wherein the memory system determines the validity of the physical address using state information of the L2P map data.

14. The data processing system of claim 13, wherein the state information comprises invalid address information, dirty information and unmap information.

15. The data processing system of claim 13, wherein the memory system performs the unmap operation comprises by changing a value of state information corresponding to the first physical address or a logical address mapped to the first physical address to invalidate the valid first physical address.

16. The data processing system of claim 12, wherein the L2P map data stored in the memory system comprises first verification information generated based on an encryption of the L2P map data and second verification information generated based on an update version of the L2P map data.

17. The data processing system of claim 16, wherein the memory system determines the validity of the physical address using the first verification information or the second verification information.

18. A controller comprising:
a memory suitable for storing L2P map data and state information of the L2P map data; and
an operation performance module suitable for performing an unmap operation to invalidate a physical address, which is received together with an unmap request from an external device, by changing a value of the state information corresponding to the physical address.

19. The controller of claim 18, wherein the L2P map data represents relationships between logical addresses and physical addresses of a plurality of nonvolatile memory elements.

20. The controller of claim 19, wherein the operation performance module transmits at least a portion of the L2P map data to the external device.

21. An operating method of a data processing system, the operating method comprising:
storing, by a memory system, at least L2P map data and validity information of a valid piece within the L2P map data;
caching, by a host, at least a portion of the L2P map data;
providing, by the host, the memory system with an unmap request along with a physical address, which is retrieved from the cached portion; and
invalidating, by the memory system, the validity information corresponding to the physical address in response to the unmap request.
